(19) United States
(12) Patent Application Publication
(10) Pub. No.: US 2025/0348760 A1
(43) Pub. Date: Nov. 13, 2025

(54) METHOD, DEVICE, AND SYSTEM FOR DETECTING ABNORMALITY OF SEMICONDUCTOR EQUIPMENT

(71) Applicant: Samsung Electronics Co., Ltd., Suwon-si (KR)

(72) Inventors: Jinhong Lim, Suwon-si (KR); Hyeon Ko, Suwon-si (KR); Euiseok Kum, Suwon-si (KR); Kihong Kim, Suwon-si (KR); Daeyeon Lee, Suwon-si (KR); Seungho Lee, Suwon-si (KR); Jinyoun Lee, Suwon-si (KR)

(21) Appl. No.: 19/050,237

(22) Filed: Feb. 11, 2025

(30) Foreign Application Priority Data
May 8, 2024 (KR) 10-2024-0060745
Dec. 9, 2024 (KR) 10-2024-0181952

(51) Int. Cl. G06N 5/022

(52) U.S. Cl. CPC G06N 5/022

(57) ABSTRACT

Provided is a method, performed by a computing system, of detecting an abnormality, the method including generating, a plurality of training data sets from respective history data of the plurality of pieces of equipment, generating, based on the plurality of training data sets, a plurality of machine learning models respectively corresponding to the plurality of pieces of equipment, determining, based on a plurality of feature importance sets respectively corresponding to the plurality of machine learning models, a plurality of inefficiency indices respectively corresponding to the plurality of pieces of equipment, and identifying, based on the plurality of inefficiency indices, at least one piece of abnormal equipment among the plurality of pieces of equipment.

### CROSS-REFERENCE TO RELATED APPLICATION

This application is based on and claims priority under 35 U.S.C. § 119 to Korean Patent Application Nos. 10-2024-0060745, filed on May 8, 2024, and 10-2024-0181952, filed on Dec. 9, 2024, in the Korean Intellectual Property Office, the disclosures of which are incorporated by reference herein in their entireties.

### BACKGROUND

The inventive concept relates to technology for detecting an abnormality of semiconductor equipment.

In general, numerous unit processes are performed to produce a complete semiconductor product through a series of semiconductor fabrication processes. For the semiconductor fabrication processes, a plurality of pieces of semiconductor fabrication equipment (e.g., chemical vapor deposition (CVD) equipment, sputtering equipment, etching equipment, measurement equipment, etc.) may be arranged in a semiconductor fabrication line. The pieces of semiconductor fabrication equipment may perform the semiconductor fabrication processes according to a planned process sequence. The fabrication efficiency of the semiconductor fabrication processes may vary depending on not only the recipes of the unit processes, but also may depend on whether a predetermined non-process is performed between unit processes. Performing an unnecessary non-process may increase inefficiency in the pieces of semiconductor fabrication equipment. To increase the fabrication efficiency of the semiconductor fabrication processes, it may be necessary to detect abnormalities resulting from non-processes.

### SUMMARY

The inventive concept provides a computing system for evaluating the efficiency or inefficiency of equipment through the result of analyzing a machine learning model established using data about equipment in a semiconductor fabrication line, and detecting an abnormality of the equipment if the efficiency or inefficiency of the equipment is less than a reference level. However, the objectives of the inventive concept are not limited to those mentioned above, and other objectives will be clearly understood by those skilled in the art from the following descriptions.

According to some embodiments of the inventive concept, there is provided a method, performed by a computing system, of detecting an abnormality, the method including establishing communication with a data collection server, receiving history data of each of a plurality of pieces of equipment from the data collection server, classifying operations of each of the plurality of pieces of equipment into process operations or non-process operations, the operations being included in the history data of each of the plurality of pieces of equipment, generating, based on a result of the classifying, a plurality of training data sets respectively corresponding to the plurality of pieces of equipment from respective history data of the plurality of pieces of equipment, generating, based on the plurality of training data sets, a plurality of machine learning models respectively corresponding to the plurality of pieces of equipment, determining, based on a plurality of feature importance sets respectively corresponding to the plurality of machine learning models, a plurality of inefficiency indices respectively corresponding to the plurality of pieces of equipment, and identifying, based on the plurality of inefficiency indices, at least one piece of abnormal equipment among the plurality of pieces of equipment.

According to some embodiments of the inventive concept, there is provided a method, performed by a computing system, of detecting an abnormality, the method including establishing communication with a data collection server, receiving history data of each of a plurality of pieces of equipment from the data collection server, classifying a plurality of operations included in the history data of one piece of equipment among the plurality of pieces of equipment into process operations or non-process operations, generating, based on a result of the classifying, a plurality of interval training data sets respectively corresponding to a plurality of time intervals from the history data of the one piece of equipment, generating, based on the plurality of interval training data sets, a plurality of machine learning models respectively corresponding to the plurality of time intervals, and identifying, based on a plurality of feature importance sets respectively corresponding to the plurality of machine learning models, at least one abnormal interval among the plurality of time intervals.

According to some embodiments of the inventive concept, there is provided a method, performed by a computing system, of detecting an abnormality, the method including establishing communication with a data collection server, receiving history data of each of a plurality of pieces of equipment from the data collection server, classifying operations of each of the plurality of pieces of equipment into process operations or non-process operations, the operations being included in the history data of each of the plurality of pieces of equipment, obtaining, based on the history data of each of the plurality of pieces of equipment, process program identifications (PPIDs) of all operations classified as the process operations, generating a PPID similarity matrix by identifying a PPID similarity between the PPIDs of all operations classified as the process operations, generating a non-process statistics matrix based on the history data of each of the plurality of pieces of equipment, generating an abnormality detection matrix based on the PPID similarity matrix and the non-process statistics matrix, and identifying, based on the abnormality detection matrix, at least one PPID setting abnormality of one piece of equipment among the plurality of pieces of equipment.

### BRIEF DESCRIPTION OF THE DRAWINGS

Embodiments will be more clearly understood from the following detailed description taken in conjunction with the accompanying drawings in which:

FIG. 1 is a diagram illustrating an example of a computing system for processing data, according to some embodiments;

FIG. 2 is a flowchart illustrating a method of detecting an abnormality of equipment, according to some embodiments;

FIGS. 3A and 3B are drawings illustrating examples of abnormalities of equipment according to some embodiments;

FIG. 4 is a flowchart illustrating an example of a method of detecting an abnormality of equipment, according to some embodiments;

FIG. 5 illustrates examples of history data collected for equipment and an operation flowchart of the equipment obtained from the history data, according to some embodiments;

FIG. 6 is a diagram illustrating an example of classifying an operation of equipment and determining a type of a non-process operation, according to some embodiments;

FIG. 7 illustrates an example of an operation flowchart of a chamber included in equipment, according to some embodiments;

FIG. 8 is a diagram illustrating an example of an operation of determining a machine learning model, according to some embodiments;

FIG. 9 is a diagram illustrating an example of an operation of determining calculation of an inefficiency index, according to some embodiments;

FIG. 10 is a diagram illustrating an example of an operation of detecting an abnormality of equipment based on an inefficiency index of the equipment and an inefficiency index of another equipment, according to some embodiments;

FIG. 11 is a diagram illustrating an example of an operation of detecting an abnormality of equipment by using a feature importance set corresponding to each of a plurality of time intervals of the equipment, according to some embodiments;

FIG. 12 is a flowchart illustrating an example of an operation of detecting abnormal equipment among a plurality of pieces of equipment, according to some embodiments;

FIG. 13 is a diagram illustrating an example of an operation of detecting an abnormality on an equipment group basis, according to some embodiments;

FIG. 14 is a flowchart illustrating an example of an operation of detecting an abnormality of equipment, according to another embodiment;

FIG. 15 is a block diagram illustrating an example configuration of a computing system according to some embodiments;

FIG. 16 is a flowchart illustrating an example of a method of detecting an abnormality of equipment, according to some embodiments;

FIG. 17 illustrates examples of an operation flowchart and a process program identification (PPID) of equipment according to some embodiments;

FIG. 18 is a diagram illustrating an example of an operation of identifying a PPID similarity, according to some embodiments;

FIG. 19 is a diagram illustrating an example of an operation of calculating a characteristic index, according to some embodiments;

FIG. 20 is a diagram illustrating an example of an operation of determining a weighted index of equipment, according to some embodiments;

FIG. 21 is a graph illustrating an example of an operation of identifying abnormal equipment, according to some embodiments;

FIG. 22 is a flowchart illustrating an example of an operation of identifying a PPID setting abnormality of equipment, according to some embodiments;

FIG. 23 is a diagram illustrating an example of an operation of generating a PPID similarity matrix, according to some embodiments;

FIG. 24 is a diagram illustrating an example of an operation of identifying a preceding non-process performance frequency, according to some embodiments;

FIG. 25 illustrates examples of an operation flowchart and PPID of equipment according to some embodiments;

FIG. 26 is a diagram illustrating an example of an operation of generating a non-process statistics matrix, according to some embodiments;

FIG. 27 is a diagram illustrating an example of an operation of generating an abnormality detection matrix X, according to some embodiments; and

FIG. 28 is a diagram illustrating an example of an operation of identifying a PPID setting abnormality, according to some embodiments.

### DETAILED DESCRIPTION

Hereinafter, embodiments will be described in detail with reference to the accompanying drawings. When describing the embodiments with reference to the accompanying drawings, like reference numerals refer to like components, and any repeated description related thereto will be omitted.

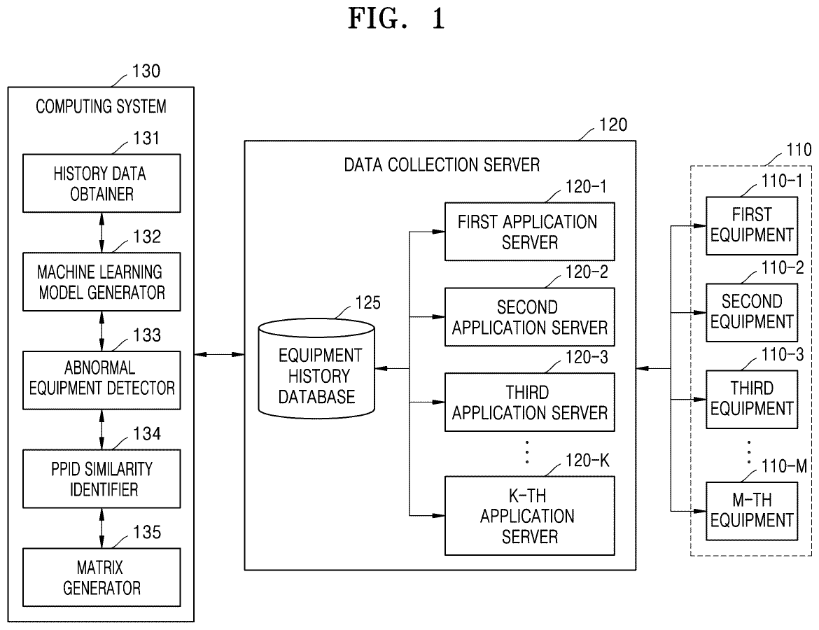

FIG. 1 is a diagram illustrating an example of a computing system for processing data, according to some embodiments.

Referring to FIG. 1, a fabrication line for fabricating semiconductors may include one or more pieces of equipment 110. The one or more pieces of equipment 110 may include, for example, first equipment 110-1, second equipment 110-2, third equipment 110-3, . . . , and M-th equipment 110-M, but the number of pieces of equipment included in the fabrication line is not limited. Here, M may be an integer greater than or equal to “1”. The one or more pieces of equipment 110 may process a plurality of wafers and/or wafer lots. The one or more pieces of equipment 110 may perform operations according to a semiconductor fabrication process.

A wafer lot may include a plurality of wafers. Wafers and/or wafer lots may be used to produce semiconductors. Each of the one or more pieces of equipment 110 may have one or more chambers. A chamber may be a space provided in a corresponding piece of equipment (e.g., the first equipment 110-1), and an operation according to the fabrication process may be performed in the chamber.

The semiconductor fabrication process may include process operations and non-process operations. The process operations may be operations to cause changes in at least a portion of a wafer and may include, for example, lithography, metrology, etching, ion injection, deposition, and the like. The non-process operations may be operations distinct from the process operations and may be operations for pre-processing or post-processing of the process operations. For example, the non-process operations may include an operation of controlling the internal environment (e.g., the temperature, humidity, and/or pressure) of a chamber, and a cleaning operation to clean the chamber.

Process operations on wafers may be performed in a chamber. A wafer may be brought into equipment (e.g., the first equipment 110-1) from outside the equipment. Changes may be induced in at least a portion of the wafer by a process operation performed while the wafer is placed in a chamber of the equipment. When the process operation of the equipment assigned to the wafer is completed, the wafer may be taken out of the equipment to the outside of the equipment. However, embodiments are not limited to performing a process operation in the chamber, and a non-process operation may also be performed in the chamber.

For example, the non-process operation may be performed while no wafer is placed in the chamber. In another example, the non-process operation may be performed while a wafer (e.g., a dummy wafer) independent of the process operation is placed in the chamber. A wafer on which the process operation has been performed may be taken out of the equipment and used for production of a portion of a semiconductor device. In contrast, a dummy wafer may not be taken out of the equipment even after the non-process operation of the equipment is completed and may be repeatedly used for a subsequent non-process operation.

The one or more pieces of equipment 110 may perform non-process operations when trigger conditions for the non-process operations are met. The trigger conditions for the non-process operations may be set based on a parameter related to the internal environment of the chamber (e.g., the temperature, humidity, pressure, and/or concentration of gas), a parameter related to the process operations performed in the chamber, or a parameter related to the process operations to be performed in the chamber (e.g., process program identification (PPID)). As described later, the efficiency of the equipment may be degraded due to errors in setting parameters related to the trigger conditions for the non-process operations of the equipment (e.g., setting errors caused by an administrator).

Each piece of equipment may generate records corresponding to operations performed by the corresponding piece of equipment. For example, the state of the first equipment 110-1 may change depending on an operation (e.g., a process operation and/or a non-process operation) performed by the first equipment 110-1. When the state of the first equipment 110-1 changes, the first equipment 110-1 may generate a record corresponding to the change in the state of the first equipment 110-1. The state of the equipment may include the state of each chamber mounted on the equipment. For example, when an operation (e.g., a process operation and/or a non-process operation) starts in the chamber, the state of the chamber may change. When the performance of operations in the chamber is completed, the state of the chamber may change. Each piece of equipment may transmit information recording the state of the equipment over time to a data collection server 120.

Each piece of equipment may further include a transport device (not shown) to transport a wafer and a monitoring device (not shown) to monitor a loaded wafer. The transport device to transport a wafer may include a robot to control (e.g., assist with) transport of a wafer, when loading the wafer into the equipment, when transporting the wafer within the equipment (e.g., transporting from a first chamber to a second chamber), or when taking the wafer out of the equipment. The monitoring device may include a sensor (e.g., a camera sensor) to detect a wafer placed in or near the equipment and monitor the state. Each piece of equipment may generate information related to the state of the equipment through the transport device or the monitoring device.

The data collection server 120 may collect information about the one or more pieces of equipment 110. For example, the data collection server 120 may include a plurality of application servers 120-1, 120-2, 120-3, through 120-K. Here, k may be an integer greater than or equal to “1”. The plurality of application servers 120-1, 120-2, 120-3, through 120-K may collect, from the one or more pieces of equipment 110, records corresponding to operations performed within a chamber of the one or more pieces of equipment 110. The plurality of application servers 120-1, 120-2, 120-3, through 120-K may collect information obtained through the transport device or monitoring device included in the one or more pieces of equipment 110.

The data collection server 120 may collect information about returning a wafer or wafer lot (also referred to as “lot” in various embodiments) between the one or more pieces of equipment 110 included in the fabrication line. A lot may refer to a unit of wafers to be transported, including a predetermined number (e.g., 25) of wafers. For example, the data collection server 120 may collect a record indicating that a wafer has been returned from the first equipment 110-1 to the second equipment 110-2. The data transmitted from the one or more pieces of equipment 110 to the data collection server 120 may be referred to as event logs. The plurality of application servers 120-1, 120-2, 120-3, through 120-K may obtain history data about each piece of equipment, by processing (e.g., classifying) the records corresponding to the operations and the information (e.g., the event logs) obtained through the transport device or monitoring device according to the corresponding piece of equipment. The plurality of application servers 120-1, 120-2, 120-3, through 120-K may store the obtained history data in an equipment history database 125.

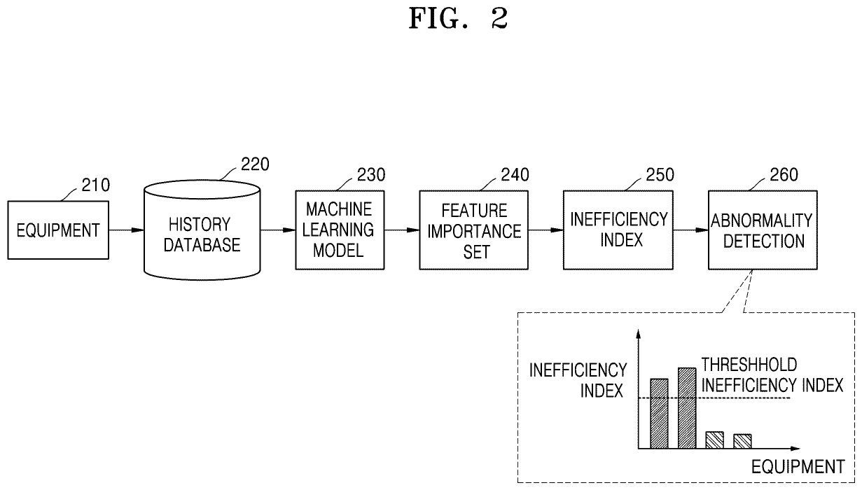

A computing system 130 may process data (e.g., history data) collected from the fabrication line including the one or more pieces of equipment 110 for performing a fabrication process and may detect an abnormality (e.g., efficiency degradation due to errors in setting parameters related to non-process trigger conditions) of the one or more pieces of equipment 110. For example, the computing system 130 may include a history data obtainer 131, a machine learning model generator 132, an abnormal equipment detector 133, a PPID similarity identifier 134, and a matrix generator 135. The history data obtainer 131 may obtain history data about at least one piece of equipment from the data collection server 120. The history data obtainer 131 may establish communication with the data collection server 120 and may receive history data stored in the equipment history database 125. The machine learning model generator 132 may generate a machine learning model that is trained based on the history data about the equipment. As described later, a machine learning model corresponding to specific equipment may be a model that copies the characteristics (e.g., the relationship between a portion of history data and a non-process type) of the equipment. The abnormal equipment detector 133 may detect abnormal equipment by using a result of analyzing the machine learning model. The PPID similarity identifier 134 may identify a similarity between a plurality of PPIDs. In addition, the matrix generator 135 may generate a PPID similarity matrix, a non-process statistics matrix, and/or an abnormality detection matrix based on the history data and/or PPID similarity for the equipment. An operation of the computing system 130 to detect abnormal equipment will be described in detail below with reference to FIGS. 2 to 28.

FIG. 2 is a flowchart illustrating a method of detecting an abnormality of equipment according to some embodiments.

Equipment 210 may generate information (e.g., event logs) about operations performed in the equipment 210. A data collection server (e.g., the data collection server 120 of FIG. 1) may collect the information about the operations of the equipment 210 and convert the collected information into history data. The history data may be stored in a history database 220. The history data may include a history of a plurality of operations (e.g., process operations and non-process operations) performed in a chamber of the equipment 210.

The computing system 130 may generate a machine learning model 230 corresponding to the equipment 210 using the history data of the equipment 210 obtained from the history database 220. When fabrication equipment includes a plurality of pieces of equipment, the computing system 130 of FIG. 1 may establish machine learning models respectively for the plurality of pieces of equipment.

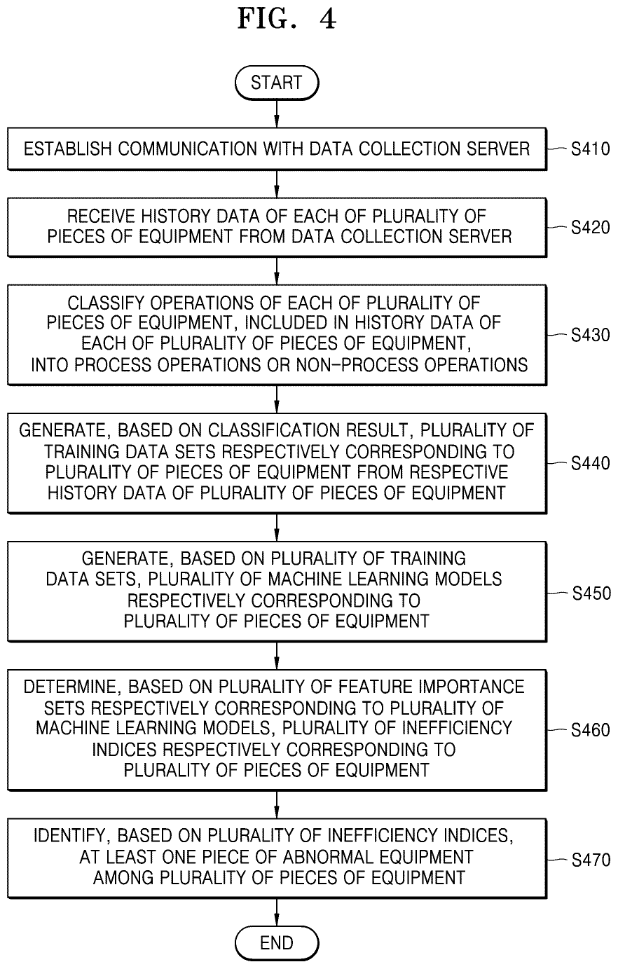

The machine learning model 230 corresponding to the equipment 210 may be a model designed and trained to output classification results for non-process types of the operations performed in the equipment 210 from a portion (e.g., wafer-related information and chamber-related information) of the history data of the equipment 210. In the inventive concept, non-processes are divided into a plurality of types, and the classification results for the non-process types of the operations described above may include information indicating the types of non-process operations and the classes of corresponding types. The computing system 130 may extract values corresponding to some features related to non-processes from the history data. In the inventive concept, the features may be individual items or categories that classify information related to operations performed in a chamber and may include, for example, an item or category related to a wafer (e.g., the number of wafers), and an item or category related to a chamber (e.g., a chamber identifier). The computing system 130 of FIG. 1 may generate input data including feature values of a plurality of features from the history data of the equipment. The features of the input data of the machine learning model 230 will be described in more detail later with reference to FIGS. 4 to 7. The machine learning model 230 may be interpreted as one that copies or models the relationship between a predetermined feature of the history data of the equipment 210 and a non-process classification, as the characteristics of the equipment 210.

When the characteristics of the equipment 210 change, the computing system 130 may regenerate the machine learning model 230 corresponding to the equipment 210. For example, when the characteristics of the equipment 210 change, the computing system 130 may generate a machine learning model having learned the changed characteristics of the equipment 210 independently of the previous machine learning model that learned the previous characteristics of the equipment 210 (e.g., ignoring the previous machine learning model). When the characteristics of the equipment 210 change, the computing system 130 may regenerate the machine learning model 230 using history data collected after the change in the characteristics.

For example, when the settings for the equipment 210 (e.g., the trigger conditions for non-process operations or settings of the parameters related to the trigger conditions) change, the characteristics of the equipment 210 may change. As another example, when the role of the equipment 210 within the fabrication line changes, the characteristics of the equipment 210 may change according to the change in the role of the equipment 210. The role of the equipment 210 may refer to the operations performed by the equipment 210 in the fabrication line, and may be defined, for example, as steps included in a process path.

However, the computing system 130 according to various embodiments is not limited to regenerating the machine learning model 230 according to the change in the characteristics of the equipment 210 or the role of the equipment 210. For example, the computing system 130 may periodically detect an abnormality of the equipment 210. When the computing system 130 detects an abnormality of the equipment 210 for each of a first time interval and a second time interval, a first machine learning model may be generated based on history data collected in the first time interval. The computing system 130 may regenerate a second machine learning model based on history data collected in the second time interval, independently of the first machine learning model (e.g., not using the parameter values of the first machine learning model).

The computing system 130 may determine a feature importance set 240 of the generated machine learning model 230. The feature importance set 240 may indicate the extent to which each feature of input data influences output data (e.g., a classification result for a non-process type) of the machine learning model 230. By analyzing the machine learning model 230, the computing system 130 may calculate a feature importance for each of the plurality of features and may generate the feature importance set 240 including a plurality of feature importance values respectively for the plurality of features. The analysis of the machine learning model 230 for generating the feature importance set 240 or determining the feature importance set 240 will be described later with reference to FIG. 4.

The computing system 130 may calculate an inefficiency index 250 by using the feature importance set 240. The inefficiency index 250 may indicate a degraded level of the efficiency of operations performed by the equipment 210.

The computing system 130 may perform abnormality detection 260 for the equipment 210 based on the inefficiency index 250. An abnormality of the equipment 210 may indicate that the efficiency of the operations performed by the equipment 210 is degraded than a reference level (e.g., a threshold inefficiency index value).

According to some embodiments, due to errors in setting parameters related to the trigger conditions for non-process operations, the efficiency of operations performed in the equipment 210 may be lower than the reference level. For example, while a series of process operations are performed for a wafer, the equipment 210 may perform a predetermined non-process operation, which is between process operations, when one or more parameters set in the equipment 210 satisfy the trigger condition for the corresponding non-process operation. If there are errors in setting the parameters related to the trigger condition for the non-process operation, an unnecessary non-process operation may be performed even though the non-process operation does not need to be performed in reality, which may cause a degradation in the efficiency of the operations performed in the equipment 210. However, the cause of the degradation in the efficiency of the equipment 210 is not limited to performing an unnecessary non-process operation, and the efficiency of the equipment 210 may be degraded due to not performing an essential non-process operation.

Trigger conditions for non-process operations may be set complexly according to at least one of the equipment 210, non-process operations performable in the equipment 210, or process operations performable in the equipment 210. In order to detect an abnormality of the equipment 210, the computing system 130 or a user (e.g., an administrator) may check the settings of the parameters related to the trigger conditions for the non-process operations for each piece of equipment 210, which may be time and computation consuming.

As described above, the computing system 130 may perform abnormality detection 260 for the equipment 210 accurately and quickly using an index (e.g., an inefficiency index) calculated from the result of analyzing the machine learning model 230 that copies the characteristics of the equipment 210.

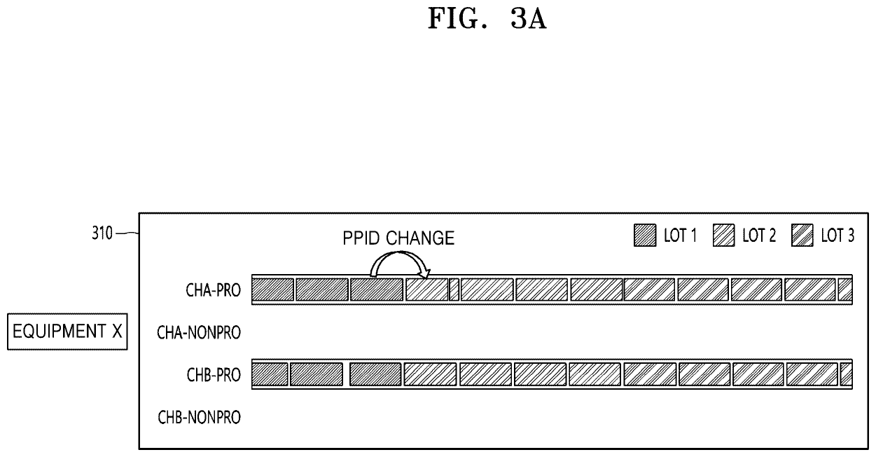

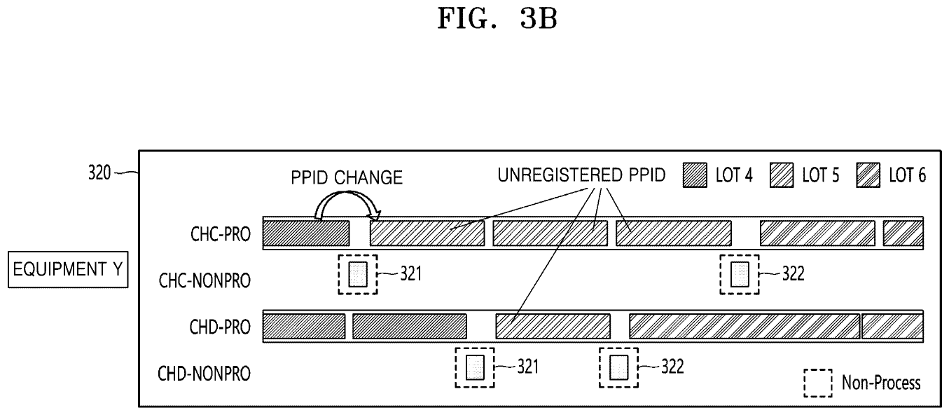

FIGS. 3A and 3B are diagrams illustrating examples of abnormalities of equipment according to some embodiments.

Equipment may sequentially perform process operations for respective lots in a chamber. For example, the equipment may sequentially perform, in the chamber, a first process operation for wafers of a first lot (LOT1), a second process operation for wafers of a second lot (LOT2), and a third process operation for wafers of a third lot (LOT3).

If the trigger condition for a non-process operation is met, the equipment may perform the non-process operation in the chamber, between a preceding process operation (e.g., the first process operation) and a subsequent process operation (e.g., the second process operation). For example, the trigger condition for the non-process operation may include a condition regarding the relationship between the PPID of the preceding process operation and the PPID of the subsequent process operation (e.g., whether the PPIDs are the same). As an example of a parameter related to the trigger conditions, the PPID may be an identifier of a program that describes a process operation for a wafer. For example, if the PPID of the first process operation and the PPID of the second process operation are the same or similar, the equipment may skip the non-process operation after the first process operation and perform the second process operation. If the PPID of the first process operation and the PPID of the second process operation are dissimilar (i.e., different from one another), the equipment may perform the non-process operation after the first process operation. In this case, the equipment may perform the second process operation after completing the non-process operation.

The equipment may store information about PPID groups into which a plurality of PPIDs are grouped. The equipment may determine that PPIDs included in the same PPID group are similar to each other and that PPIDs included in different PPID groups are dissimilar to each other. Information about the PPID groups stored in the equipment may be set by a user (e.g., an engineer or administrator). A PPID group indicates the extent to which PPIDs are the same or similar and is input by the user, and errors in the user input may cause an abnormality of the equipment. Hereinafter, with reference to FIGS. 3A and 3B, a case where errors in setting information about PPID groups cause an abnormality of equipment that an unnecessary non-process operation is performed will be described.

FIG. 3A illustrates an example in which the state of Equipment X changes over time, and FIG. 3B illustrates an example in which the state of Equipment Y changes. Equipment X may include Chamber A (CHA) and Chamber B (CHB). In an operation flowchart 310, the state of Equipment X may include a process operation state of Chamber A (CHA-PRO), a non-process operation state of Chamber A (CHA-NONPRO), a process operation state of Chamber B (CHB-PRO), and a non-process operation state of Chamber B (CHB-NONPRO). Equipment Y may include Chamber C (CHC) and Chamber D (CHD). In an operation flowchart 320, the state of Equipment Y may include a process operation state of Chamber C (CHC-PRO), a non-process operation state of Chamber C (CHC-NONPRO), a process operation state of Chamber D (CHD-PRO), and a non-process operation state of Chamber D (CHD-NONPRO).

Equipment X may sequentially perform a first process operation for a first lot (LOT1), a second process operation for a second lot (LOT2), and a third process operation for a third lot (LOT3). Equipment Y may sequentially perform a first process operation for a fourth lot (LOT4), a second process operation for a fifth lot (LOT5), and a third process operation for a sixth lot (LOT6).

For example, to increase the equipment efficiency, the PPIDs of the first process operation, the second process operation, and the third process operation may need to be classified as the same PPID. In the information about PPID groups normally set in Equipment X, the PPIDs of the first process operation, the second process operation, and the third process operation may be grouped as the same PPID group. It may be assumed that due to errors in setting the information about PPID groups set in Equipment Y, the PPID of the fifth process operation for the fifth lot (LOT5) is omitted from the PPID groups. In this case, in Equipment Y, the first process operation and the third process operation are classified as the same PPID group, but the PPID of the second process operation may be classified as a PPID group different from that of the PPID of the first process operation or the third process operation.

As shown in the operation flowchart 310, Equipment X may skip a non-process operation, as a result of classifying the PPIDs of the first process operation, the second process operation, and the third process operation as the same PPID group, for both Chamber A and Chamber B.

As shown in the operation flowchart 320, Equipment Y may perform a non-process operation 321 between the first process operation and the second process operation, as a result of classifying the PPIDs of the first process operation and the second process operation as different PPID groups, for both Chamber C and Chamber D. Likewise, Equipment Y may perform a non-process operation 322 between the second process operation and the third process operation, as a result of classifying the PPIDs of the second process operation and the third process operation as different PPID groups. As the non-process operations 321 and 322 are performed, the efficiency of Equipment Y may be degraded.

The computing system 130 may calculate an inefficiency index of Equipment Y from the result of analyzing a machine learning model that copies Equipment Y. The computing system 130 may detect an abnormality of Equipment Y using the inefficiency index of Equipment Y. For example, the computing system 130 may detect an abnormality of Equipment Y by comparing the inefficiency indices of Equipment X and Equipment Y. The inefficiency index of Equipment X, similar to Equipment Y, may be calculated from the result of analyzing a machine learning model that copies Equipment X.

FIG. 4 is a flowchart illustrating an example of a method of detecting an abnormality of equipment, according to some embodiments.

Referring to FIG. 4, in operation S410, the computing system 130 may establish communication with the data collection server 120.

In operation S420, the computing system 130 may receive history data of each of a plurality of pieces of equipment (e.g., the first equipment 110-1, the second equipment 110-2, the third equipment 110-3, . . . , and the M-th equipment 110-M) from the data collection server 120.

In operation S430, the computing system 130 may classify operations of each of the plurality of pieces of equipment, which are included in the history data of each of the plurality of pieces of equipment, into process operations or non-process operations.

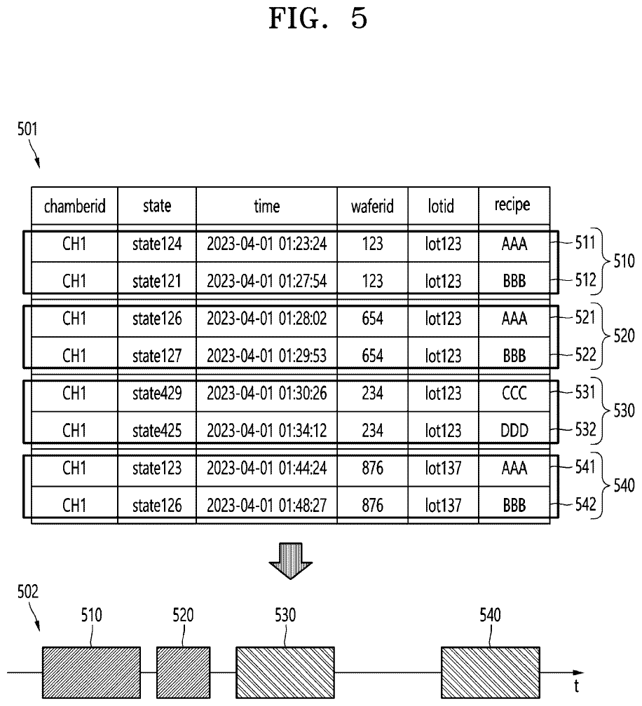

The computing system 130 may determine (e.g., extract) operations performed by the equipment from the history data about the state of the equipment. Because the state of a predetermined chamber changes as an operation (e.g., a process operation or a non-process operation) is performed in the corresponding chamber, the history data about the state may contain information about the operation performed in the corresponding chamber. For reference, as described above with reference to FIG. 1, the state of the equipment may include the state of each chamber mounted on the equipment (e.g., a process operation state of the chamber or a non-process operation state of the chamber). Extracting the operations from the history data about the state will be described later with reference to FIG. 5.

The computing system 130 may divide or classify the extracted operation as one of a process operation or a non-process operation. As described above with reference to FIG. 1, the process operation may be an operation that causes a designed change in at least a portion of a loaded wafer. The non-process operation may include an operation performed while a wafer is not placed in the chamber or while a dummy wafer is placed in the chamber. The computing system 130 may divide or classify the operation using a portion related to the extracted operation in the history data.

In operation S440, the computing system 130 may generate, based on an operation classification result, a plurality of training data sets respectively corresponding to the plurality of pieces of equipment from respective history data of the plurality of pieces of equipment. Each of the plurality of training data sets may include a plurality of training pairs, and each of the plurality of training pairs may include input data (a training input) and output data (a training output).

The computing system 130 may generate input data including a plurality of features for a chamber and a wafer related to the operation performed by the equipment, based on a history data. At least a portion of the plurality of features included in the input data may represent information about the chamber and wafer related to the operation. For example, the plurality of features may include at least one of a feature related to a chamber of the equipment used during the operation (e.g., a chamber feature), a feature related to an idle time for the operation (e.g., an idle time feature), a feature related to a program corresponding to the operation (e.g., a program feature), or a feature related to a wafer loaded during the operation (e.g., a wafer feature). The plurality of features included in the input data may be selected in advance by a user (e.g., an administrator), but are not limited thereto. The computing system 130 may generate the input data with feature values corresponding to the plurality of features selected in advance from the history data described above.

For example, the chamber feature may include a feature indicating an identifier of the chamber (e.g., a chamber identifier feature) and a feature indicating a type of the chamber (e.g., a chamber type feature). The idle time feature may include a feature (e.g., an idle time feature) indicating an idle time before the operation or another operation related to the operation (e.g., a preceding operation or a subsequent operation). For example, the program feature may indicate information about a program corresponding to the operation. The program corresponding to the operation may include environmental information (e.g., the temperature, pressure, time, and concentration of gas) inside the chamber related to the operation performed in the chamber. The program corresponding to the operation may be expressed as a recipe. If the operation is a process operation, the identifier of the program corresponding to the process operation may be expressed as a PPID. The wafer feature may include a feature indicating the number of wafers on which a processing operation is performed in the chamber (e.g., a wafer number feature), and a feature indicating a history of PPIDs of processing operations performed on the wafers (e.g., a wafer PPID history feature).

The operation of generating input data from history data will be described in more detail later with reference to FIGS. 5 to 7.

In operation S450, the computing system 130 may generate, based on the plurality of training data sets, a plurality of machine learning models respectively corresponding to the plurality of pieces of equipment. The machine learning models may be models that receive input data and output classification results for non-process types of operations as output data.

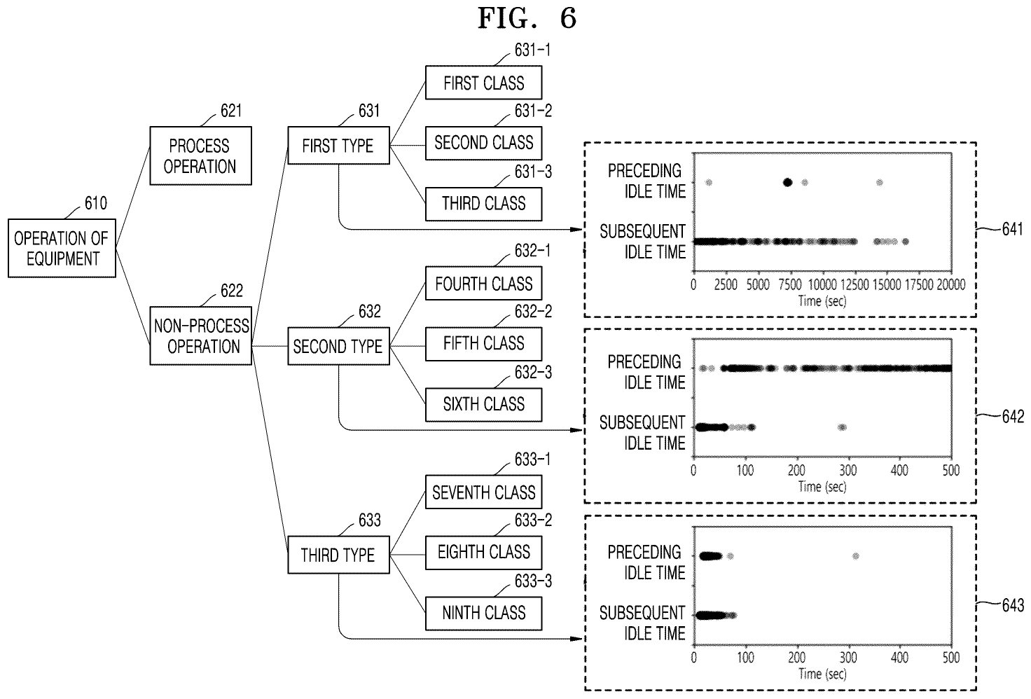

A classification result for a non-process type for a predetermined operation may include information indicating the class to which the operation belongs among a plurality of classes. The plurality of classes may be defined based on types of non-process operations and/or sub-types of the types. The types of non-process operations, which will be described in more detail later with reference to FIG. 6, may be defined based on the wafer on which the non-process operations are performed or the trigger conditions. The sub-types of non-process operations may be types defined more specifically according to the characteristics of the operations performed in the non-process operations. For example, the plurality of classes may include a class corresponding to a process operation (e.g., a class indicating that it is not a non-process operation) and classes respectively corresponding to the sub-types of the non-process operations.

According to some embodiments, a machine learning model may be implemented as a decision tree-based model. For example, the machine learning model may include a model based on the extreme gradient boost (XGBoost) algorithm. However, the machine learning model according to various embodiments is not limited to a decision tree-based model, and the machine learning model may be implemented as a neural network-based model.

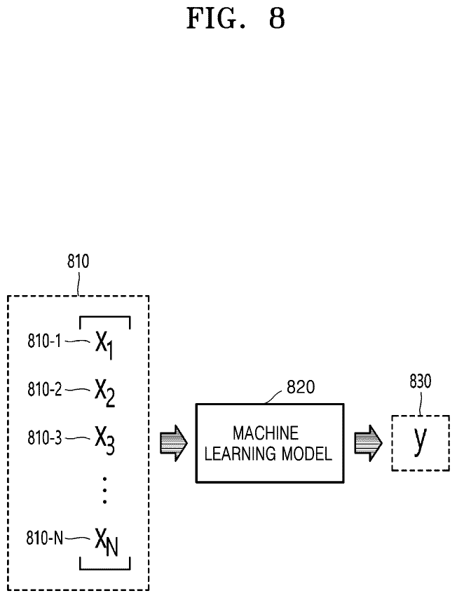

By using input data corresponding to an operation performed by specific equipment as a training input of a training pair for a machine learning model, the computing system 130 may generate a machine learning model that has learned the characteristics of the specific equipment. The generation of the machine learning model will be described in more detail later with reference to FIG. 8.

In operation S460, the computing system 130 may determine, based on a plurality of feature importance sets respectively corresponding to the plurality of machine learning models, a plurality of inefficiency indices respectively corresponding to the plurality of pieces of equipment.

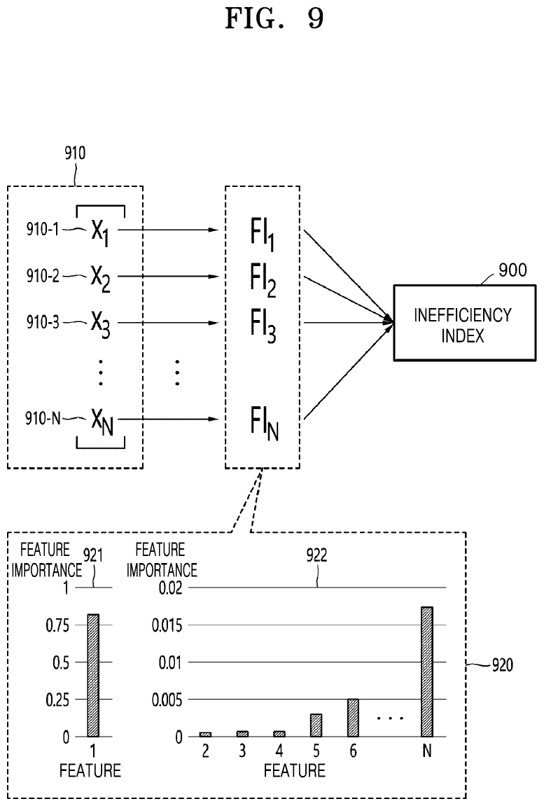

The computing system 130 may calculate (or determine) an inefficiency index of the equipment by using a feature importance set including feature importance values of a plurality of features, which are obtained as a result of analyzing a machine learning model. As described above with reference to FIG. 1, a feature importance may indicate the extent to which each feature of input data corresponding to a process influences a classification result for a non-process type of the process. For example, when a feature importance value of a first feature is greater than a feature importance value of a second feature, the first feature has greater influence on a classification result for a non-process type of an operation than the second feature. For example, the feature importance of a feature may be determined based on an information gain or a gini index indicating the performance of a class classification result according to a feature value of the feature. In addition, the feature importance of the feature may include a permutation importance indicating a change in the performance of the classification result according to a change in the feature value of the feature. The computing system 130 may calculate an inefficiency index of the equipment by using a feature importance set. The computing system 130 may calculate the inefficiency index of the equipment by using at least some of the plurality of feature importance sets. The calculation (or determination) of the inefficiency index of the equipment will be described in more detail later with reference to FIG. 9.

In operation S470, the computing system 130 may identify, based on the plurality of inefficiency indices, at least one piece of abnormal equipment among the plurality of pieces of equipment. The computing system 130 may identify an abnormality of the equipment by comparing the inefficiency index of the equipment with a threshold inefficiency index. For example, the threshold inefficiency index may be determined based on the inefficiency indices of the plurality of pieces of equipment. The computing system 130 may calculate the inefficiency indices of the plurality of pieces of equipment. The computing system 130 may set the threshold inefficiency index based on the distribution of inefficiency indices. Accordingly, the computing system 130 may detect an abnormality of the equipment based on the inefficiency index of the equipment and an inefficiency index of another equipment. However, embodiments are not limited thereto, and as another example, the threshold inefficiency index may be preset by a user (e.g., an engineer).

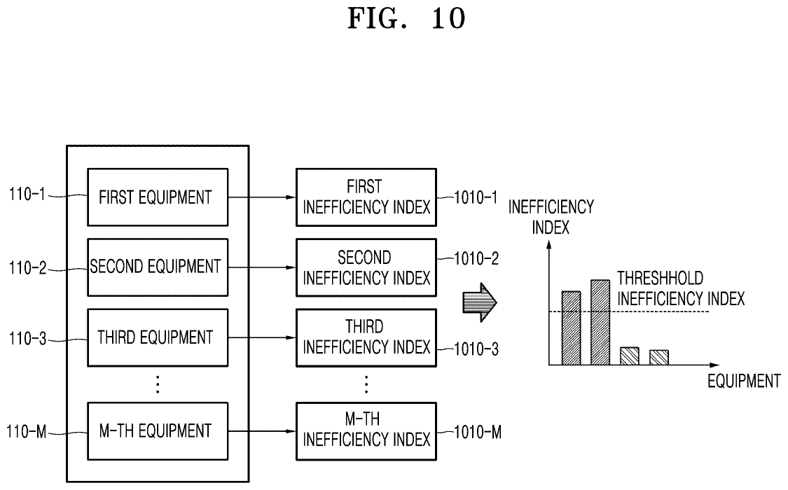

The computing system 130 may determine equipment having an inefficiency index being an outlier among the inefficiency indices of the plurality of pieces of equipment to be abnormal equipment. The abnormal equipment may be equipment with an abnormality, and may be equipment having an inefficiency index that exceeds the threshold inefficiency index. The operation of detecting an abnormality of equipment using the threshold inefficiency index will be described in more detail later with reference to FIG. 10.

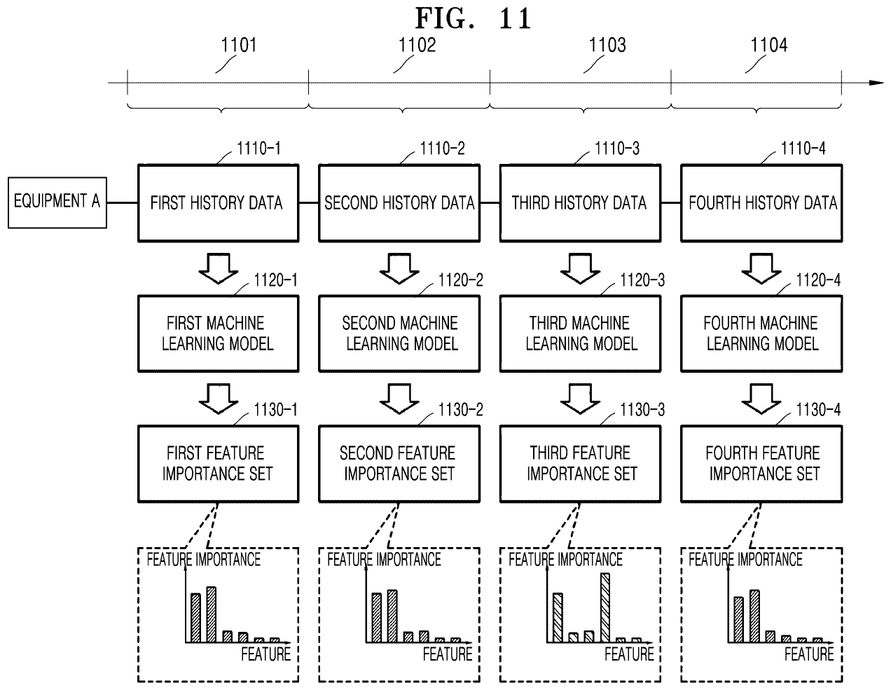

In addition, the computing system 130 may periodically determine the inefficiency index of the equipment and detect an abnormality of the equipment according to a change in the inefficiency index of the equipment. For example, the computing system 130 may determine an inefficiency index of the equipment for each of a plurality of time intervals. The computing system 130 may detect an outlier among the inefficiency indices of the equipment for different time intervals, thereby detecting that the equipment has an abnormality in the time interval showing the outlier. The operation of detecting an abnormality of equipment using inefficiency indices of the equipment for the plurality of time intervals will be described in more detail later with reference to FIG. 11.

FIG. 5 illustrates examples of history data collected for equipment and an operation flowchart of the equipment obtained from the history data according to some embodiments.

The computing system 130 according to some embodiments may obtain history data about the state of equipment. Referring to FIG. 5, history data may include records regarding changes in the state of equipment. Each record may include item values of a plurality of items including a chamber identifier (e.g., chamberid in FIG. 5), a state, a time, a wafer identifier (e.g., waferid in FIG. 5), a lot identifier (e.g., lotid in FIG. 5), and a recipe.

In FIG. 5, only records regarding changes in the state of one chamber (CH1) included in equipment are shown as examples of history data, but embodiments are not limited thereto. If the equipment includes a plurality of chambers, the history data may include records regarding changes in the states of the plurality of chambers. Each record may correspond to a change in the state of a chamber.

For example, a record 511 may indicate that the state of the chamber (CH1) changed to state124 at 01:23:24 on Apr. 1, 2023, the identifier of a wafer placed in the chamber (CH1) is 123, the identifier of a lot to which the wafer belongs is lot123, and the identifier of a recipe is AAA. A record 512 may indicate that the state of the chamber (CH1) changed to state121 at 01:27:54 on Apr. 1, 2023, the identifier of a wafer placed in the chamber (CH1) is 123, the identifier of a lot to which the wafer belongs is lot123, and the identifier of a recipe is BBB.

If the equipment includes at least one chamber, the computing system 130 may extract operations performed in each chamber from the history data. The computing system 130 may generate input data corresponding to each of a plurality of operations performed in at least one chamber of the equipment. For example, the computing system 130 may extract records 501 regarding changes in the state of the chamber (CH1) from the history data of the equipment. The computing system 130 may extract operations performed in a predetermined chamber based on the records 501 regarding the changes in the state of the chamber (CH1).

Referring to FIG. 5, the computing system 130 may determine that each record of a change in the state of the chamber (CH1) corresponds to the start or completion of an operation performed in the chamber (CH1). For example, the computing system 130 may determine that the record 511 and the record 512 correspond to the start and completion of a first operation 510 performed in the chamber (CH1). In a similar manner, the computing system 130 may determine that a record 521 and a record 522 correspond to the start and completion of a second operation 520 performed in the chamber (CH1), determine that a record 531 and a record 532 correspond to the start and completion of a third operation 530 performed in the chamber (CH1), and determine that a record 541 and a record 542 correspond to the start and completion of a fourth operation 540 performed in the chamber (CH1). As a result, the computing system 130 may extract the first operation 510, the second operation 520, the third operation 530, and the fourth operation 540 from the records 501 regarding the changes in the state of the chamber (CH1).

The computing system 130 may divide or classify the history data into a plurality of items of partial history data respectively corresponding to a plurality of operations of the equipment, based on changes in the state of the equipment shown in the history data. The computing system 130 may divide the records 501 included in the history data into partial history data including records corresponding to the start and completion of each operation. The computing system 130 may determine at least a portion of feature values of a plurality of features based on each partial history data, thereby determining input data representing an operation corresponding to the partial history data.

In FIG. 5, the computing system 130 may divide the records 501 included in the history data into a plurality of items of partial history data. The computing system 130 may divide the record 511 and the record 512 as first partial history data corresponding to the first operation 510. The computing system 130 may divide the record 521 and the record 522 as second partial history data corresponding to the second operation 520. The computing system 130 may divide the record 531 and the record 532 as third partial history data corresponding to the third operation 530. The computing system 130 may divide the record 541 and the record 542 as partial history data corresponding to the fourth operation 540.

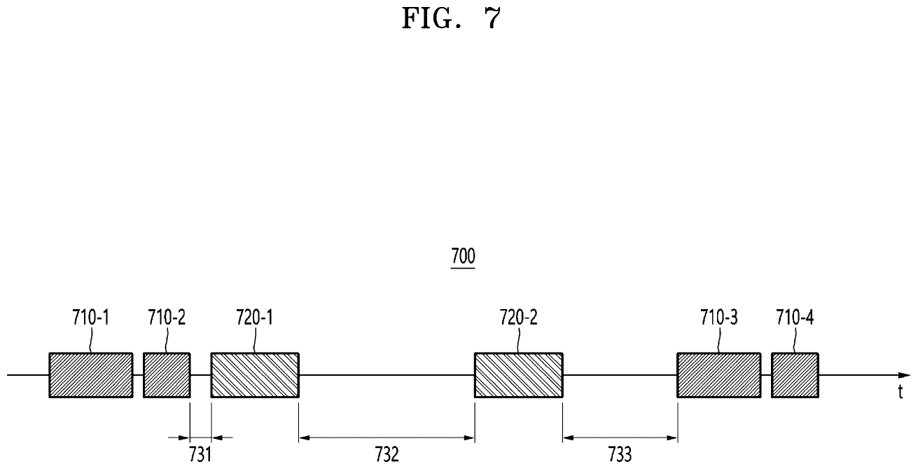

The computing system 130 may generate input data corresponding to each operation using a portion corresponding to the operation in the history data. For example, the computing system 130 may determine at least a portion of feature values of a plurality of features representing the first operation 510 based on the record 511 and the record 512. The computing system 130 may generate first input data having feature values of the first operation 510. Similarly, the computing system 130 may generate second input data by determining feature values of a plurality of features representing the second operation 520 based on the record 521 and the record 522. The computing system 130 may generate third input data by determining feature values of a plurality of features representing the third operation 530 based on the record 531 and the record 532. The computing system 130 may generate fourth input data by determining feature values of a plurality of features representing the fourth operation 540 based on the record 541 and the record 542. An example of determining feature values of an operation will be described in more detail later with reference to FIG. 7.

An operation flowchart 502 of FIG. 5 shows operations performed in the chamber (CH1) extracted from the records 501 by the computing system 130. The records 501 may represent that the first operation 510, the second operation 520, the third operation 530, and the fourth operation 540 are sequentially performed in the chamber (CH1) over time t.

FIG. 6 is a diagram illustrating an example of dividing or classifying an operation of equipment and determining a type of a non-process operation according to some embodiments. The computing system 130 may use the result of dividing or classifying an operation 610 of equipment as a process operation 621 or a non-process operation 622 to determine feature values representing the operation 610. The computing system 130 may extract a plurality of operations performed by the equipment from history data. The computing system 130 may divide or classify each operation 610 as the process operation 621 or the non-process operation 622. For example, the computing system 130 may divide or classify the operation 610 as the process operation 621 or the non-process operation 622 based on an item value of a state item among records regarding the start and end of the operation 610 in the history data.

When the computing system 130 divides or classifies the operation 610 as the non-process operation 622, the computing system 130 may determine the type of the non-process operation 622. The computing system 130 may determine input data for the operation based on the type of the non-process operation 622.

The type of the non-process operation 622 may be divided according to idle time. For example, the computing system 130 may determine the type of the operation based on a preceding idle time or a subsequent idle time. When the operation 610 performed by the equipment is divided or classified as the non-process operation 622, the computing system 130 may calculate a preceding idle time or a subsequent idle time of the operation from the history data. The preceding idle time of the operation may refer to the length of time from the completion time of an operation preceding the operation (e.g., an operation performed immediately before in the same chamber) to the start time of the operation. The subsequent idle time of the operation may refer to the length of time from the completion time of the operation to the start time of an operation subsequent to the operation (e.g., an operation performed immediately after in the same chamber). Examples of a preceding idle time and a subsequent idle time will be described in more detail below with reference to FIG. 7.

The computing system 130 may select the type of the operation from a plurality of candidate types based on the determined preceding idle time or subsequent idle time. For example, the computing system 130 may select the type of the operation divided or classified as the non-process operation 622 as one of the plurality of candidate types. The plurality of candidate types may include a first type 631, a second type 632, and a third type 633.

The first type 631 of the non-process operation 622 may indicate that the non-process operation is performed based on a wafer loaded before the non-process operation. The first type 631 may refer to a type performed for post-processing of a process operation on a wafer loaded before a non-process operation (herein, also referred to as a “post-processing non-process type”). The first type 631 may be a type of a non-process operation in which a trigger condition for the non-process operation includes a condition for parameters related to a preceding operation before the non-process operation or a wafer loaded before the non-process operation.

The second type 632 of the non-process operation 622 may indicate that the non-process operation is performed based on a wafer to be loaded after the non-process operation. The second type 632 may refer to a type performed for pre-processing of a process operation for a wafer to be loaded after a non-process operation (herein, also referred to as a “pre-processing non-process type”). The second type 632 may be a type of a non-process operation in which a trigger condition for the non-process operation includes a condition for parameters related to a subsequent operation that is subsequent to the non-process operation or a wafer loaded after the non-process operation.

The third type 633 of the non-process operation 622 may indicate that the non-process operation is performed independently of the loading of a wafer. The third type 633 may refer to a type performed to maintain the environment of the chamber (herein, also referred to as an “environment-maintaining non-process type”). The third type 633 may be a type of a non-process operation in which a trigger condition for the non-process operation includes a condition for parameters (e.g., the elapse of a reference time) independent of another process or another wafer.

Each of the first type 631, the second type 632, and the third type 633 of the non-process operation 622 may be further divided more specifically into classes. For example, as shown in FIG. 6, the first type 631 may be subdivided into a first class 631-1, a second class 631-2, and a third class 631-3, the second type 632 may be subdivided into a fourth class 632-1, a fifth class 632-2, and a sixth class 632-3, and the third type 633 may be subdivided into a seventh class 633-1, an eighth class 633-2, and a ninth class 633-3. A machine learning model described below may be designed to output a class of an operation. The output representing a class will be described with reference to FIG. 8.

The computing system 130 may calculate a non-process type index to classify the type of the non-process operation 622. For example, the computing system 130 may calculate the non-process type index based on the ratio between a preceding idle time and a subsequent idle time. The computing system 130 may select the type of the operation 610 as one of the first type 631, the second type 632, and the third type 633 based on the non-process type index. The computing system 130 may determine feature values for the operation 610 based on the selected type.

For reference, FIG. 6 shows, for example, the distributions of preceding idle times and subsequent idle times of operations of the first type 631, the second type 632, and the third type 633. The idle time distribution of operations of each type is not directly used to classify the type, but is shown to describe the temporal characteristics of each type. The distributions of preceding idle times and subsequent idle times of operations of the first type 631, the second type 632, and the third type 633 may be different from each other. Each of graphs 641, 642, and 643 shows the distribution of preceding idle times and subsequent idle times of operations of a corresponding type. As shown in the graph 641, the preceding idle times of the operations of the first type 631 may be mostly equal to a predetermined value (e.g., 7000 seconds) or have a difference less than or equal to a threshold, and the subsequent idle times of the operations of the first type 631 may have a distribution with various values. As shown in the graph 642, the preceding idle times of the operations of the second type 632 may have values distributed over a predetermined range (e.g., 0 seconds or longer to 500 seconds or shorter), and the subsequent idle times of the operations of the second type 632 may mostly have values distributed over a predetermined range (e.g., 0 seconds or longer to 100 seconds or shorter). As shown in the graph 643, the preceding idle times of the operations of the third type 633 may mostly have values distributed over a predetermined range (e.g., 0 seconds or longer to 100 seconds or shorter), and the subsequent idle times of the operations of the third type 633 may mostly have values distributed over a predetermined range (e.g., 0 seconds or longer to 100 seconds or shorter).

FIG. 7 illustrates an example of an operation flowchart of a chamber included in equipment according to some embodiments.

The computing system 130 according to some embodiments may extract six operations performed in a chamber from history data, and divide or classify each operation as a process operation or a non-process operation. For example, an operation flowchart 700 is a flowchart showing operations performed in a chamber over time t, and may represent the result of extracting and dividing a first process operation 710-1, a second process operation 710-2, a first non-process operation 720-1, a second non-process operation 720-2, a third process operation 710-3, and a fourth process operation 710-4.

The computing system 130 may determine the type of each of the first non-process operation 720-1 and the second non-process operation 720-2.

For example, the computing system 130 may determine a preceding idle time of the first non-process operation 720-1 to be a first length of time 731. The computing system 130 may determine a subsequent idle time of the first non-process operation 720-1 to be a second length of time 732. The computing system 130 may select the type of the first non-process operation 720-1 using the preceding idle time or subsequent idle time of the first non-process operation 720-1. For example, in FIG. 7, the computing system 130 may select the type of the first non-process operation 720-1 as a first type (e.g., a post-processing non-process type).

For example, the computing system 130 may determine a preceding idle time of the second non-process operation 720-2 to be the second length of time 732. The computing system 130 may determine a subsequent idle time of the second non-process operation 720-2 to be a third length of time 733. The computing system 130 may select the type of the second non-process operation 720-2 using the preceding idle time or subsequent idle time of the second non-process operation 720-2. For example, in FIG. 7, the computing system 130 may select the type of the second non-process operation 720-1 as a second type (e.g., a pre-processing non-process type).

The computing system 130 may determine feature values of input data based on the selected type of the operation. For example, when the type of the operation is determined to be the first type (e.g., the post-processing non-process type), the computing system 130 may determine feature values for the operation using a portion related to the operation and a preceding operation that precedes the operation in the history data. The first type, as in FIG. 6, may indicate that the operation is performed based on a wafer loaded before the operation.

In the example shown in FIG. 7, when the type of the first non-process operation 720-1 is selected as the first type, the computing system 130 may determine feature values for the first non-process operation 720-1 using a portion related to the first non-process operation 720-1 and a preceding operation (e.g., the first process operation 710-1 or the second process operation 710-2) that precedes the first non-process operation 720-1 in the history data. The first type is a post-processing non-process type, and the first non-process operation 720-1 of the first type may have characteristics based on the preceding operation (e.g., the first process operation 710-1 or the second process operation 710-2).

When the type of the first non-process operation 720-1 is selected as the first type, the computing system 130 may determine the first non-process operation 720-1 to be closely connected with an operation (e.g., the second process operation 710-2) immediately before the first non-process operation 720-1. For example, the computing system 130 may use information about the operation (e.g., the second process operation 710-2) immediately before the first non-process operation 720-1 to determine a feature value of the first non-process operation 720-1. For example, the computing system 130 may determine a feature value of a feature of the first non-process operation 720-1 based on the relationship between the first process operation 710-1 preceding the first non-process operation 720-1 and the second process operation 710-2 and the first non-process operation 720-1 and the second process operation 710-2.

For example, the feature value of a program feature of the first non-process operation 720-1 may be determined based on PPIDs between process operations (e.g., the first process operation 710-1 and the second process operation 710-2) preceding the first non-process operation 720-1. When the type of the first non-process operation 720-1 is selected as the first type (e.g., the post-processing non-process type), the computing system 130 may determine the feature values of the first non-process operation 720-1 independently of operations subsequent to the first non-process operation 720-1.

For example, the feature value of an idle time feature of the first non-process operation 720-1 may be determined based on an idle time between a process operation (e.g., the second process operation 710-2) preceding the first non-process operation 720-1 and a process operation (e.g., the first process operation 710-1) preceding the preceding process operation (e.g., the second process operation 710-2).

According to some embodiments, when the type of the first non-process operation 720-1 is selected as the first type (e.g., the post-processing non-process type), the computing system 130 may determine the feature values of the first non-process operation 720-1 considering only the operations preceding the first non-process operation 720-1. In this case, the feature values of the first non-process operation 720-1 may be determined independently of operations subsequent to the first non-process operation 720-1.

When the type of the operation is determined to be the second type (e.g., the pre-processing non-process type), the computing system 130 may determine feature values for the operation using a portion related to the operation and a subsequent operation that is subsequent to the operation in the history data. The second type, like in FIG. 6, may indicate that the operation is performed based on a wafer to be loaded after the operation.

In the example shown in FIG. 7, when the type of the second non-process operation 720-2 is selected as the second type, the computing system 130 may determine feature values for the second non-process operation 720-2 using a portion related to the second non-process operation 720-2 and a subsequent operation (e.g., the third process operation 710-3 or the fourth process operation 710-4) that is subsequent to the second non-process operation 720-2 in the history data. The second type is a pre-processing non-process type, and the second non-process operation 720-2 of the second type may have characteristics based on the subsequent operation (e.g., the third process operation 710-3 or the fourth process operation 710-4).

When the type of the second non-process operation 720-2 is selected as the second type, the computing system 130 may determine feature values of the second non-process operation 720-2 using a portion related to an operation subsequent to the second non-process operation 720-2 in the history data. However, embodiments are not limited thereto, and the computing system 130 may determine the feature values of the second non-process operation 720-2 using a portion related to an operation preceding the second non-process operation 720-2 together with the portion related to the operation subsequent to the second non-process operation 720-2.

When the type of the second non-process operation 720-2 is selected as the second type, the computing system 130 may determine the second non-process operation 720-1 to be closely connected with an operation (e.g., the third process operation 710-3) immediately after the second non-process operation 720-2. For example, the computing system 130 may use information about the operation (e.g., the third process operation 710-3) immediately after the second non-process operation 720-2 to determine a feature value of the second non-process operation 720-2. For example, the computing system 130 may determine a feature value of a feature of the second non-process operation 720-2 based on the relationship between the second process operation 710-2 preceding the second non-process operation 720-2 and the third process operation 710-3 and the second non-process operation 720-2 and the third process operation 710-3.

For example, the feature value of a program feature of the second non-process operation 720-2 may be determined based on PPIDs between a process operation (e.g., the second process operation 710-2) preceding the second non-process operation 720-2 and a process operation (e.g., the third process operation 710-3) subsequent to the second non-process operation 720-2.

For example, the feature value of an idle time feature of the second non-process operation 720-2 may be determined based on an idle time (e.g., the second length of time 732) between the second non-process operation 720-2 and an operation (e.g., the first non-process operation 720-1) preceding the second non-process operation 720-2.

When the type of the operation is determined to be the third type (e.g., the environment-maintaining non-process type), the computing system 130 may determine feature values for the operation using a portion related to the operation and a subsequent operation that is subsequent to the operation, similarly to the second type (e.g., the pre-processing non-process type). The description of determining feature values when the type of the operation divided or classified as a non-process operation is determined to be the third type is the same as that when the type of the operation is determined to be the second type and thus, is omitted.

FIG. 8 is a diagram illustrating an example of determining a machine learning model according to some embodiments.

The computing system 130 according to some embodiments may generate a machine learning model 820 having learned the characteristics of equipment. The machine learning model 820 may include a model trained to output a classification result 830 for a non-process type from input data 810.

The input data 810 may include, as described above, feature values of a plurality of features. In FIG. 8, for example, the input data 810 may include feature values of N features (e.g., a feature value 810-1 of a first feature, a feature value 810-2 of a second feature, a feature value 810-3 of a third feature, . . . , and a feature value 810-N of an N-th feature. Here, N may be an integer greater than or equal to “1”. The plurality of features may represent, as described above, information related to an operation. As described above with reference to FIGS. 4 to 7, the computing system 130 may generate input data 810 corresponding to each operation by determining feature values of a plurality of features representing the corresponding operation.

As described above with reference to FIG. 4, the classification result 830 for the non-process type of the operation may include information indicating the non-process type corresponding to the operation and/or a class into which the non-process type is subdivided. Each non-process type may be subdivided into a plurality of classes. For example, the plurality of classes may include a class corresponding to a process operation (e.g., not being a non-process operation) and classes respectively corresponding to the sub-types of a non-process operation.

For a plurality of operations of equipment shown in history data, the computing system 130 may obtain a training pair (e.g., training data) including a training input and a training output representing each operation. For example, the computing system 130 may obtain, as a training input, the input data 810 generated for the operation from the history data. The computing system 130 may determine, based on the history data, a true value class to which the operation belongs and may obtain the determined true value class as a training output.

The computing system 130 may generate a plurality of training data sets respectively corresponding to a plurality of pieces of equipment (e.g., the first equipment 110-1, the second equipment 110-2, the third equipment 110-3, . . . , and the M-th equipment 110-M). Here, each of the plurality of training data sets respectively corresponding to the plurality of pieces of equipment may include a plurality of training pairs generated from history data of each of the plurality of pieces of equipment.

For example, a training data set corresponding to the first equipment 110-1 may include a plurality of training pairs respectively representing a plurality of operations included in history data of the first equipment 110-1. Here, the plurality of training pairs respectively representing the plurality of operations included in the history data of the first equipment 110-1 may include a training input (e.g., feature values of a plurality of features) and a training output (e.g., a classification result for a non-process type corresponding to an operation) for each of the plurality of operations.

The computing system 130 may generate a machine learning model 820 by updating parameters of the machine learning model 820 based on a training data set. For example, the computing system 130 may obtain a temporary classification result by applying a temporary machine learning model to a training input. The temporary machine learning model may refer to the machine learning model 820 before the update of parameters is completed, for example, the machine learning model 820 that is being trained. The computing system 130 may calculate a temporary output (e.g., a temporary classification result) by applying a computation according to the temporary machine learning model to the training input. The computing system 130 may update parameters of the temporary machine learning model based on the temporary classification result and a loss function. When the update of the parameters of the temporary machine learning model based on the training data set is completed, the computing system 130 may determine the temporary machine learning model of which the parameters have been updated as the machine learning model 820.

FIG. 9 is a diagram illustrating an example of determining calculation of an inefficiency index according to some embodiments.

The computing system 130 may calculate an inefficiency index 900 using a feature importance of each feature of input data 910 of a generated machine learning model.

The computing system 130 may determine feature importance values of a plurality of features for the generated machine learning model. As described above with reference to FIG. 4, the computing system 130 may determine a feature importance by analyzing a machine learning model based on at least one of an information gain, a gini index, or a permutation importance. In FIG. 9, the machine learning model to be analyzed may be trained to receive a plurality of features (e.g., a first feature 910-1, a second feature 910-2, a third feature 910-3, . . . , and an N-th feature 910-N) as the input data 910. The computing system 130 may determine feature importance values of a plurality of features in the number of N (e.g., a first feature importance (FI1), a second feature importance (FI2), a third feature importance (FI3), . . . , and an N-th feature importance (FIN)). For convenience of description, feature importance values of a plurality of features are referred to as a “feature importance set”. For example, a feature importance set corresponding to a specific machine learning model may include the first feature importance (FI1), the second feature importance (FI2), the third feature importance (FI3), . . . , and the N-th feature importance (FIN).

In FIG. 9, a graph 920 illustrates an example of a plurality of feature importance values included in one feature importance set. In the graph 920, due to a difference in size between the plurality of feature importance values, the plurality of feature importance values are shown in two partial graphs 921 and 922. The partial graph 921 shows the first feature importance (FI1) of the first feature, and the partial graph 922 briefly shows the second feature importance (FI2) of the second feature through the N-th feature importance (FIN) of the N-th feature.

The computing system 130 may calculate, based on the feature importance set, an inefficiency index 900 corresponding to an abnormality of equipment. The computing system 130 may calculate the inefficiency index 900 corresponding to the abnormality of the equipment based on feature importance values of features belonging to a feature group. The feature group may be a group of features selected from among a plurality of features and may be preset according to the design of a user (e.g., an engineer).

For example, the computing system 130 may calculate the inefficiency index 900 using an index calculation model based on Equation 1 below.

$$Index {1}_{{P}_{j}} = ln [ {\sum }_{i = {s}_{k}}^{{e}_{k}} {w}_{i} \cdot exp ( \frac{{FI}_{i , {P}_{j}} - {\overline{FI}}_{i}}{{\overline{FI}}_{i}} ) ] \qquad [ Equation 1 ]$$

Here, Index 1_{P}_{ⱼ} may refer to the inefficiency index 900 calculated for equipment Pⱼ, i may refer to a feature of the input data 910, sₖ and eₖ may refer to the range of features corresponding to a feature group k, wᵢ may refer to a weight of the feature i, FI_{i,P}_{ⱼ} may refer to a feature importance of the feature i of the equipment Pⱼ, and F̅I̅ᵢ may refer to the average of feature importances of the feature i for a plurality of pieces of equipment. F̅I̅ᵢ may be a predetermined value for the feature i, or may be obtained for a plurality of pieces of equipment on which abnormality detection is to be performed.

According to some embodiments, the computing system 130 may calculate an inefficiency index 900 corresponding to a plurality of candidate abnormalities. As described above with reference to FIG. 2, an abnormality of equipment may be caused by errors in setting parameters (e.g., PPIDs) related to trigger conditions for non-process operations. In the equipment, parameters are set by a user (e.g., an engineer or administrator), and thus, errors in setting the parameters may occur due to human error.

An abnormality type of equipment may be classified according to a parameter used for the trigger conditions. For example, abnormality types of equipment may include a PPID type, a wafer type, and a chamber type. The PPID type may indicate a case where there is an error in PPID group setting of parameters for a PPID related to the trigger conditions for the non-process operations. The wafer type may indicate a case where there is an error in setting the parameters related to a wafer used as the trigger conditions for the non-process operations. The chamber type may indicate a case where there is an error in setting the parameters related to a PPID used as the trigger conditions for the non-process operations.

The computing system 130 may calculate the inefficiency index 900 based on an index calculation model corresponding to an abnormality type of the abnormality, among a plurality of index calculation models corresponding to a plurality of candidate abnormality types of the equipment. The computing system 130 may calculate the inefficiency index 900 by selecting an index calculation model corresponding to an abnormality type to be detected in the equipment from the plurality of index calculation models corresponding to the plurality of candidate abnormality types.

FIG. 10 is a diagram illustrating an example of detecting an abnormality of equipment based on an inefficiency index of the equipment and an inefficiency index of another equipment according to some embodiments.

The computing system 130 may detect an abnormality of equipment based on an inefficiency index of the equipment and an inefficiency index of another equipment. For example, the computing system 130 may obtain an inefficiency index (e.g., a comparative index) of another equipment different from the equipment. The computing system 130 may calculate a threshold inefficiency index based on inefficiency indices of a plurality of pieces of equipment, including the equipment or another equipment. The computing system 130 may determine an inefficiency index that exceeds the threshold inefficiency index to be an outlier. The computing system 130 may determine that equipment having an inefficiency index being an outlier is abnormal equipment.

For example, the computing system 130 may calculate inefficiency indices for a plurality of pieces of equipment. As shown in FIG. 10, the computing system 130 may determine respective inefficiency indices (e.g., a first inefficiency index 1010-1, a second inefficiency index 1010-2, a third inefficiency index 1010-3, . . . , and an M-th inefficiency index 1010-M) of M pieces of equipment (e.g., first equipment 110-1, second equipment 110-2, third equipment 110-3, . . . , and M-th equipment 110-M). Describing based on the first equipment 110-1, the computing system 130 may compare the inefficiency index of the first equipment 110-1 with a threshold inefficiency index determined based on the inefficiency indices of the other pieces of equipment (e.g., the second equipment 110-2, the third equipment 110-3, . . . , and the M-th equipment 110-M). The computing system 130 may detect an abnormality of the first equipment 110-1 based on a result of comparing the inefficiency index of the first equipment 110-1 with the threshold inefficiency index. For example, when the inefficiency index of the first equipment 110-1 exceeds the threshold inefficiency index, the computing system 130 may determine the first equipment 110-1 to be abnormal equipment. If the inefficiency index of the first equipment 110-1 is less than or equal to the threshold inefficiency index, the computing system 130 may determine the first equipment 110-1 to be normal equipment with no abnormality.

The threshold inefficiency index may be determined based on the distribution of the inefficiency indices of the plurality of pieces of equipment (e.g., the first equipment 110-1, the second equipment 110-2, the third equipment 110-3, . . . , and the M-th equipment 110-M). For example, the computing system 130 may determine a value obtained by adding three times the standard deviation of the inefficiency indices of the plurality of pieces of equipment to the average of the inefficiency indices of the plurality of pieces of equipment to be the threshold inefficiency index. For example, the computing system 130 may determine a value obtained by adding 1.5 times the interquartile range of the inefficiency indices of the plurality of pieces of equipment to the third quartile of the inefficiency indices of the plurality of pieces of equipment to be the threshold inefficiency index.

Referring back to the examples described above with reference to FIGS. 3A and 3B, the computing system 130 may calculate inefficiency indices for Equipment X and Equipment Y, respectively. The inefficiency index calculated for Equipment Y may have a greater value than the inefficiency index calculated for Equipment X. The computing system 130 may determine a threshold inefficiency index value by referring to the inefficiency index calculated for Equipment X. If the inefficiency index for Equipment Y exceeds the threshold inefficiency index, the computing system 130 may determine that Equipment Y is abnormal equipment.

FIG. 11 is a diagram illustrating an example of an operation of detecting an abnormality of equipment by using a feature importance set corresponding to each of a plurality of time intervals of the equipment, according to some embodiments.

The computing system 130 according to some embodiments may detect an abnormality of equipment by analyzing history data of the equipment for each of a plurality of time intervals.

The computing system 130 may use the history data for each of the plurality of time intervals to generate a machine learning model that has learned the characteristics of the equipment in the corresponding time interval. The computing system 130 may determine a feature importance set from each of machine learning models generated for respective time intervals.

In FIG. 11, the computing system 130 may obtain four items of history data (e.g., first history data 1110-1, second history data 1110-2, third history data 1110-3, and fourth history data 1110-4) for four time intervals (e.g., a first time interval 1101, a second time interval 1102, a third time interval 1103, and a fourth time interval 1104) for Equipment A.

The computing system 130 may generate a machine learning model corresponding to each time interval using history data about the state of the equipment in the corresponding time interval. For example, as shown in FIG. 11, the computing system 130 may generate a first machine learning model 1120-1 using the first history data 1110-1 about the state of the equipment in the first time interval 1101. The computing system 130 may generate a second machine learning model 1120-2 using the second history data 1110-2 about the state of the equipment in the second time interval 1102. The computing system 130 may generate a third machine learning model 1120-3 using the third history data 1110-3 about the state of the equipment in the third time interval 1103. The computing system 130 may generate a fourth machine learning model 1120-4 using the fourth history data 1110-4 about the state of the equipment in the fourth time interval 1104.

In detail, the computing system 130 may generate a first interval training data set from the first history data 1110-1, may generate a second interval training data set from the second history data 1110-2, may generate a third interval training data set from the third history data 1110-3, and may generate a fourth interval training data set from the fourth history data 1110-4.

Here, the process by which the computing system 130 generates an “interval training data set” from each time interval may be identical to the process by which the computing system 130 generates a “training data set,” described with reference to FIG. 8.

For example, the computing system 130 may obtain training input data by determining feature values of a plurality of features respectively representing a plurality of operations included in the first history data 1110-1. In addition, the computing system 130 may obtain, as training output data, a classification result for a non-process type of each of the plurality of operations included in the first history data 1110-1. In this case, the computing system 130 may obtain a plurality of items of training input data and a plurality of items of training output data, which are obtained from the first history data 1110-1, as a plurality of training pairs, and the plurality of training pairs may be referred to as first interval training data.

Based on the same principle as the operation described above, the computing system 130 may generate second interval training data, third interval training data, and fourth interval training data respectively corresponding to the second time interval 1102, the third time interval 1103, and the fourth time interval 1104.

The computing system 130 may generate a machine learning model for each time interval by training the machine learning model based on interval training data corresponding to each time interval.

The computing system 130 may determine a feature importance set of a machine learning model for each time interval.

The computing system 130 may determine whether an abnormality has occurred in the equipment in the first time interval 1101 or the second time interval 1102 by comparing a first feature importance set 1130-1 for the first machine learning model 1120-1 with a second feature importance set 1130-2 for the second machine learning model 1120-2. For example, the computing system 130 may determine whether an abnormality has occurred in the equipment in the first time interval 1101 or the second time interval 1102 by comparing the feature importance distribution of the first feature importance set 1130-1 with the feature importance distribution of the second feature importance set 1130-2. For example, a difference in feature importance distribution between respective feature importance sets may determine, for each feature, a difference between a feature importance of the corresponding feature in the first feature importance set 1130-1 and a feature importance of the corresponding feature in the second feature importance set 1130-2, and may be determined as a value obtained by adding up differences for each feature across a plurality of features.

In FIG. 11, differences in feature importance distribution between the first feature importance set 1130-1, the second feature importance set 1130-2, and a fourth feature importance set 1130-4 may all be determined to be less than or equal to a threshold, whereas a difference in feature importance distribution between one of the first feature importance set 1130-1, the second feature importance set 1130-2, and the fourth feature importance set 1130-4 and a third feature importance set 1130-3 may be determined to be greater than or equal to the threshold. The computing system 130 may identify the third time interval 1103 as an abnormal interval.

However, the computing system 130 according to various embodiments is not limited to determining a time interval in which an abnormality has occurred by comparing the distributions of feature importance sets. For example, the computing system 130 may determine an inefficiency index for each of a plurality of time intervals. The computing system 130 may detect, based on inefficiency indices for the plurality of time intervals, a time interval in which an abnormality of the equipment has occurred. For example, the computing system 130 may determine inefficiency indices of the equipment for the plurality of time intervals based on a feature importance set of each machine learning model. The computing system 130 may identify, based on a result of comparing each inefficiency index with a threshold inefficiency index, an abnormal interval in which an abnormality of the equipment has occurred.

Although it is shown in FIG. 11 that the plurality of time intervals (e.g., the first time interval 1101, the second time interval 1102, the third time interval 1103, and the fourth time interval 1104) do not overlap each other, embodiments are not limited thereto. For example, a portion of at least one time interval among the plurality of time intervals may overlap another time interval. In some embodiments, at least one time interval may be included in another time interval.

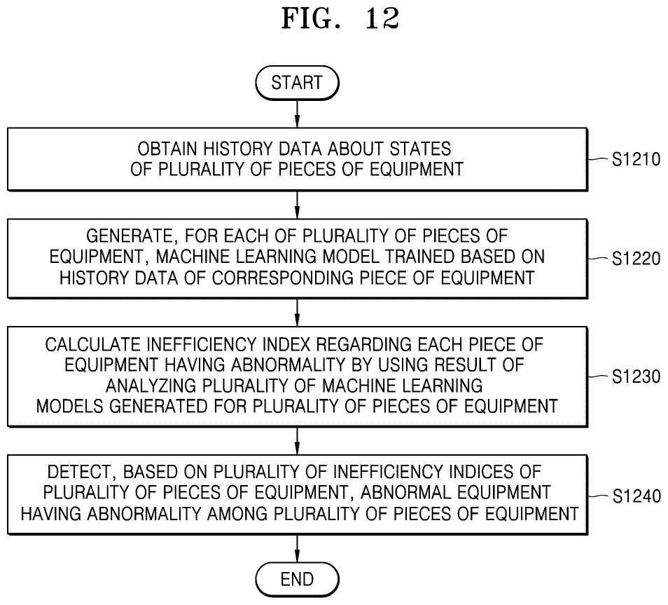

FIG. 12 is a flowchart illustrating an example of detecting abnormal equipment among a plurality of pieces of equipment according to some embodiments.

The computing system 130 may generate a machine learning model having learned the characteristics of each of a plurality of pieces of equipment, and detect abnormal equipment among the plurality of pieces of equipment using the result of analyzing machine learning models.

In operation S1210, the computing system 130 may obtain history data about the states of a plurality of pieces of equipment. The history data may indicate changes in the states of the plurality of pieces of equipment.

In operation S1220, the computing system 130 may generate, for each of the plurality of pieces of equipment, a machine learning model trained based on the history data of the corresponding piece of equipment. For example, the computing system 130 may determine a plurality of operations performed by the equipment from the history data about the equipment among the plurality of pieces of equipment. The computing system 130 may extract history data about each piece of equipment from the history data about the plurality of pieces of equipment. In the same manner or similarly to the operations described above with reference to FIGS. 4 to 11, the computing system 130 may generate a machine learning model corresponding to the equipment based on the history data about the equipment.

For example, the computing system 130 may extract a plurality of operations from history data about each piece of equipment. The computing system 130 may divide or classify each of the extracted plurality of operations as a process operation or a non-process operation. The computing system 130 may determine input data representing the corresponding operation based on a result of dividing each of the extracted plurality of operations. The computing system 130 may generate a machine learning model by updating a parameter of a machine learning model corresponding to the equipment based on a plurality of items of input data determined for the plurality of operations.

In operation S1230, the computing system 130 may calculate an inefficiency index regarding each piece of equipment having an abnormality, using the result of analyzing the plurality of machine learning models generated for the plurality of pieces of equipment.

In operation S1240, the computing system 130 may detect abnormal equipment among the plurality of pieces of equipment based on a comparison between a threshold inefficiency index based on a plurality of inefficiency indices of the plurality of pieces of equipment and each inefficiency index.

As described above with reference to FIG. 10, the computing system 130 may calculate a plurality of inefficiency indices of the plurality of pieces of equipment. The computing system 130 may determine a threshold inefficiency index based on the inefficiency indices of the plurality of pieces of equipment. The computing system 130 may detect abnormal equipment among the plurality of pieces of equipment based on a result of comparing the inefficiency index of each piece of equipment with the threshold inefficiency index.

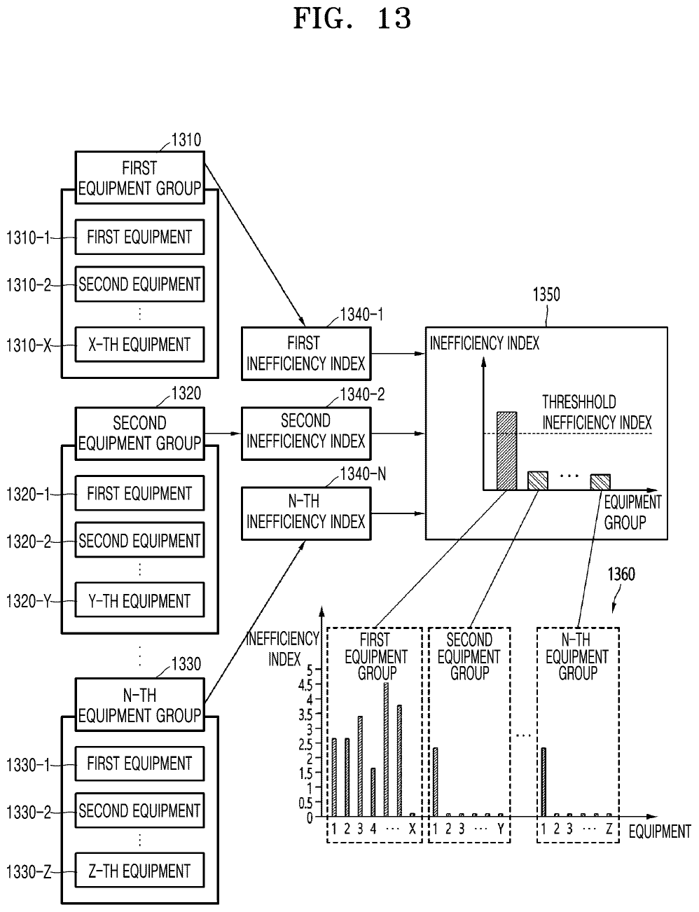

FIG. 13 is a diagram illustrating an example of detecting an abnormality on an equipment group basis according to some embodiments.

The computing system 130 may detect an abnormality on an equipment group basis. For example, the computing system 130 may obtain a result of grouping a plurality of pieces of equipment into a plurality of equipment groups. A plurality of pieces of equipment belonging to one equipment group may have similarities between operations performed in the respective pieces of equipment. For example, the plurality of pieces of equipment belonging to the one equipment group may be pieces of equipment corresponding to the same or similar step in the same process path. The plurality of pieces of equipment belonging to the one equipment group may be pieces of equipment performing the same or similar processes. The plurality of pieces of equipment belonging to the one equipment group may be pieces of equipment operating according to the same or similar operating standards.

In FIG. 13, for example, the result of grouping the plurality of pieces of equipment into N equipment groups is shown. For example, a first equipment group 1310 may include first equipment 1310-1, second equipment 1310-2, . . . , and X-th equipment 1310-X. A second equipment group 1320 may include first equipment 1320-1, second equipment 1320-2, . . . , and Y-th equipment 1320-Y. An N-th equipment group 1330 may include first equipment 1330-1, second equipment 1330-2, . . . , and Z-th equipment 1330-Z.

The computing system 130 may determine an inefficiency index of each equipment group using inefficiency indices of the pieces of equipment belonging to the corresponding equipment group. For example, the computing system 130 may calculate an inefficiency index for each of the plurality of pieces of equipment. For example, the computing system 130 may calculate inefficiency indices of the plurality of pieces of equipment (e.g., the first equipment 1310-1, the second equipment 1310-2, . . . , and the X-th equipment 1310-X) included in the first equipment group 1310. The operation of calculating or determining the inefficiency index of each piece of equipment may be performed in the same manner or similarly to the operation described above with reference to FIGS. 4 to 11. The computing system 130 may calculate the inefficiency index of each equipment group (e.g., a first inefficiency index 1340-1 of the first equipment group 1310, a second inefficiency index 1340-2 of the second equipment group 1320, . . . , and an N-th inefficiency index 1340-N of the N-th equipment group 1330) based on the inefficiency indices of the plurality of pieces of equipment included in the corresponding equipment group. For example, the computing system 130 may calculate the average of the inefficiency indices of the plurality of pieces of equipment included in the equipment group as the inefficiency index of the equipment group.

The computing system 130 may detect an abnormal equipment group including at least one piece of abnormal equipment among the plurality of equipment groups, based on inefficiency indices of the plurality of equipment groups. The computing system 130 may determine a threshold inefficiency index for the abnormal equipment group. The computing system 130 may detect an abnormal equipment group among the plurality of equipment groups based on a result of comparing the inefficiency index of each equipment group with the threshold inefficiency index.

The threshold inefficiency index for the abnormal equipment group may be determined based on the distribution of inefficiency indices of the plurality of equipment groups (e.g., the first equipment group 1310, the second equipment group 1320, . . . , and the N-th equipment group 1330). For example, the computing system 130 may determine a value obtained by adding three times the standard deviation of the inefficiency indices of the plurality of equipment groups to the average of the inefficiency indices of the plurality of equipment groups to be the threshold inefficiency index. For example, the computing system 130 may determine a value obtained by adding 1.5 times the interquartile range of the inefficiency indices of the plurality of equipment groups to the third quartile of the inefficiency indices of the plurality of equipment groups to be the threshold inefficiency index.

In FIG. 13, a graph 1350 shows examples of inefficiency indices of a plurality of equipment groups. In the graph 1350, a threshold inefficiency index for an abnormal equipment group is shown along with inefficiency indices of the plurality of equipment groups. For example, the computing system 130 may determine the first equipment group 1310, which has an inefficiency index exceeding the threshold inefficiency index, to be an abnormal equipment group.

A graph 1360 of FIG. 13 shows examples of inefficiency indices of pieces of equipment belonging to a plurality of equipment groups. In the graph 1360, a portion related to the first equipment group 1310 represents inefficiency indices of the first equipment 1310-1 through the X-th equipment 1310-X belonging to the first equipment group 1310. In the graph 1360, a portion related to the second equipment group 1320 represents inefficiency indices of the first equipment 1320-1 through the Y-th equipment 1320-Y belonging to the second equipment group 1320. In the graph 1360, a portion related to the N-th equipment group 1330 represents inefficiency indices of the first equipment 1330-1 through the Z-th equipment 1330-Z belonging to the N-th equipment group 1330. For example, as shown in the graph 1360, the pieces of equipment belonging to the first equipment group 1310, which is determined to be an abnormal equipment group, may have a tendency to have a large inefficiency index compared to the pieces of equipment belonging to another equipment group (e.g., the second equipment group 1320 or the N-th equipment group 1330).

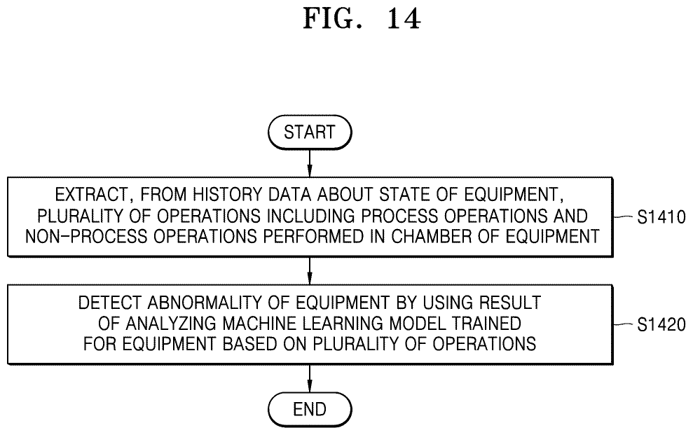

FIG. 14 is a flowchart illustrating an example of detecting an abnormality of equipment according to some embodiments.

In operation S1410, the computing system 130 may extract a plurality of operations including process operations and non-process operations performed in a chamber included in the equipment, from history data about the state of the equipment. The operation of extracting a plurality of operations from history data may be performed in the same manner or similarly to the operation described above with reference to FIGS. 4 to 11. For example, the computing system 130 may obtain a portion related to the state of the chamber (e.g., records indicating changes in the state of the chamber) in the history data. The computing system 130 may extract a plurality of operations performed within the chamber. The extracted plurality of operations may include process operations and non-process operations performed in the chamber.

In operation S1420, the computing system 130 may detect an abnormality of the equipment using the result of analyzing a machine learning model trained for the equipment based on the extracted plurality of operations.

The operation of generating a machine learning model trained for the equipment may be performed in the same manner or similarly to the operation described above with reference to FIGS. 4 to 11. For example, the computing system 130 may obtain, for each of the plurality of operations, a training pair consisting of a training input (e.g., input data) including a plurality of features for the corresponding operation, and a training output including a classification result for a non-process type. The computing system 130 may generate a machine learning model by training the machine learning model based on a training data set including a plurality of training pairs for each of the plurality of operations. The machine learning model may receive input data including a plurality of features for an operation performed by the equipment and may output a classification result for a non-process type as output data.

The training input may include feature values of a plurality of features. The computing system 130 may determine the training input based on the result of dividing or classifying each operation as a process operation or a non-process operation. For example, when a first operation and a second operation among the plurality of operations are divided or classified as non-process operations, the computing system 130 may determine the type of each of the first operation and the second operation. The computing system 130 may determine a first training input corresponding to the first operation using a portion related to the first operation and a preceding operation that precedes the first operation in the history data, when the type of the first operation is determined to be a first type indicating that the first operation is performed based on a wafer loaded before the first operation. The computing system 130 may determine a second training input corresponding to the second operation using a portion related to the second operation and a subsequent operation that is subsequent to the second operation in the history data, when the type of the second operation is determined to be a second type indicating that the second operation is performed based on a wafer to be loaded after the second operation.

The operation of detecting an abnormality of the equipment may be performed in the same manner or similarly to the operation described above with reference to FIGS. 4 to 13. For example, the computing system 130 may calculate an inefficiency index of the equipment based on a feature importance set of a machine learning model trained for the equipment. The computing system 130 may detect an abnormality of the equipment based on the inefficiency index of the equipment and an inefficiency index of another equipment.

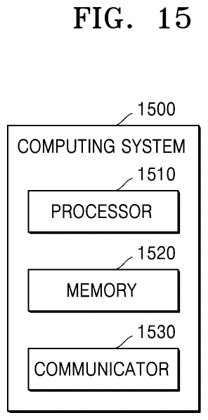

FIG. 15 is a block diagram illustrating an example configuration of a computing system according to some embodiments.

Referring to FIG. 15, a computing system 1500 (e.g., the computing system 130 of FIG. 1) may include a processor 1510, a memory 1520, and a communicator 1530.

The processor 1510 may obtain history data about the state of equipment (e.g., semiconductor equipment for fabricating semiconductors). For example, the processor 1510 may receive history data from a data collection server (e.g., the data collection server 120 of FIG. 1) through the communicator 1530 (e.g., a communication circuit). The history data may be generated by the data collection server based on information (e.g., raw data) about the equipment.

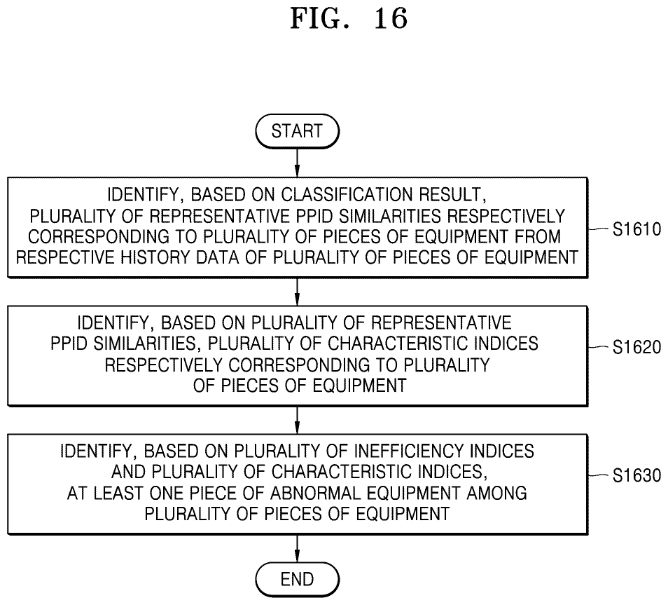

The processor 1510 may divide or classify a plurality of operations of the equipment extracted from the history data as process operations or non-process operations. The processor 1510 may generate input data including a plurality of features for a chamber and a wafer related to the operations based on a result of dividing or classifying the operations. The processor 1510 may generate a machine learning model trained to output classification results for non-process types of operations from the input data. The processor 1510 may calculate an inefficiency index of the equipment by using a feature importance set obtained as a result of analyzing the machine learning model. The processor 1510 may detect an abnormality of the equipment based on the calculated inefficiency index of the equipment. The processor 1510 may obtain a plurality of PPIDs from the history data, may identify a similarity between the obtained plurality of PPIDs, and may identify (or determine) a characteristic index and a weighted index based on the similarity between the plurality of PPIDs. In addition, the processor 1510 may generate a PPID similarity matrix, a non-process statistics matrix, and an abnormality detection matrix and may identify a PPID setting abnormality of specific equipment based on the abnormality detection matrix. Embodiments of various operations of the processor 1510, which are performed based on the plurality of PPIDs, will be described in detail below with reference to FIGS. 16 to 28.

The memory 1520 may temporarily and/or permanently store at least one of history data, input data, a plurality of features, a classification result for a non-process type, a machine learning model, a plurality of PPIDs, a PPID similarity, a PPID similarity matrix, a non-process statistics matrix, an abnormality detection matrix, a characteristic index, a weighted index, and an inefficiency index. The memory 1520 may store instructions or the like for classifying an operation, generating input data, identifying a PPID similarity, generating a PPID similarity matrix, a non-process statistics matrix, and/or an abnormality detection matrix, generating a machine learning model, calculating an inefficiency index, calculating a characteristic index, calculating a weighted index, and/or detecting an abnormality of equipment. However, the above embodiment is an example, and information stored in the memory 1520 is not limited thereto.

The communicator 1530 may transmit and receive information about at least one of the history data, the classification result for the non-process type, the input data, the machine learning model, the inefficiency index, and/or an abnormality of the equipment. The communicator 1530 may establish a wired communication channel and/or a wireless communication channel with an external device (e.g., another computing system or a server), and may, for example, establish communication with the external device through cellular communication, short-range wireless communication, local area network (LAN) communication, Bluetooth, wireless fidelity (Wi-Fi) direct or infrared data association (IrDA), or a long-range communication network such as a legacy cellular network, a fourth generation (4G) and/or fifth generation (5G) network, next generation communication, the Internet, or a computer network (e.g., LAN or WAN).

FIG. 16 is a flowchart illustrating an example of a method of detecting an abnormality of equipment, according to some embodiments.

In operation S1610, the computing system 130 may identify, based on an operation classification result, a plurality of representative PPID similarities respectively corresponding to a plurality of pieces of equipment (e.g., the first equipment 110-1, the second equipment 110-2, the third equipment 110-3, . . . , and the M-th equipment 110-M) from respective history data of the plurality of pieces of equipment.

For example, the computing system 130 may identify, based on the operation classification result, all non-process operations included in the history data of the first equipment 110-1. The computing system 130 may identify a preceding PPID and a subsequent PPID for each of all non-process operations included in the history data of the first equipment 110-1.

Here, the term “preceding PPID” may refer to a PPID of a process operation performed prior to a specific non-process operation. The term “subsequent PPID” may refer to a PPID of a process operation performed subsequent to or after a specific non-process operation.

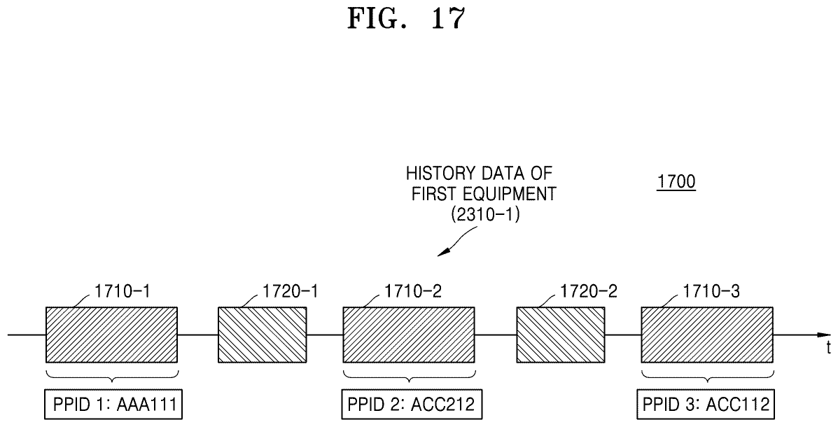

The computing system 130 may identify PPID similarities between all preceding PPIDs and subsequent PPIDs identified from the history data of the first equipment 110-1 and may identify a representative PPID similarity corresponding to the first equipment 110-1 based on the identified PPID similarities. An operation of the computing system 130 to identify a representative PPID similarity corresponding to each of the plurality of pieces of equipment will be described in detail below with reference to FIGS. 17 to 19.

In operation S1620, the computing system 130 may identify (or determine), based on the plurality of representative PPID similarities, a plurality of characteristic indices respectively corresponding to the plurality of pieces of equipment.

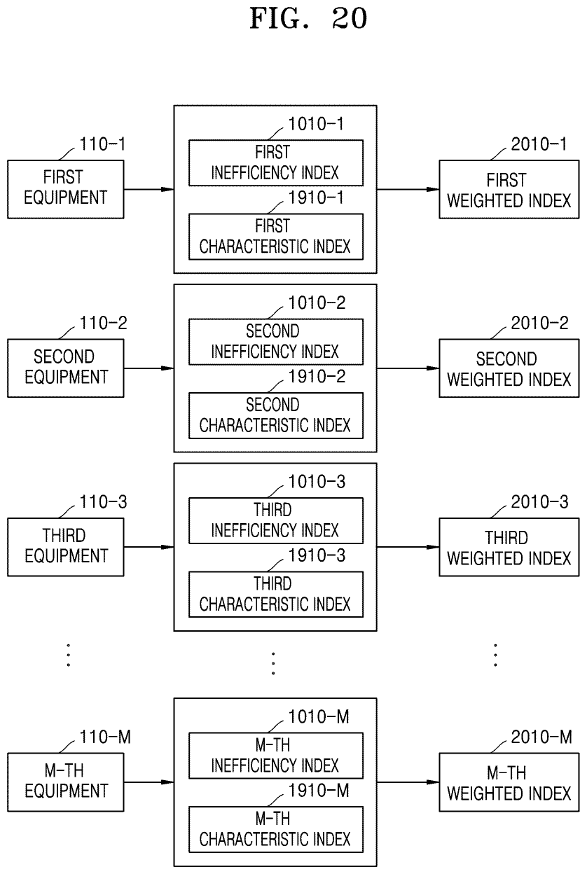

For example, the computing system 130 may identify (or determine) a plurality of characteristic indices respectively corresponding to the plurality of pieces of equipment by comparing the plurality of representative PPID similarities with each other. Here, the term “characteristic index” may refer to an index indicating the inefficiency of a non-process operation performed in specific equipment. In other words, a high characteristic index value of the first equipment 110-1 may indicate that “the performance of a plurality of non-process operations included in the history data of the first equipment 110-1 is inefficient.” In addition, herein, a characteristic index of specific equipment may be used in a weighted manner with an inefficiency index of the specific equipment, described above with reference to FIGS. 2 to 14. This aspect will be described in detail below in the description of FIG. 20.

In operation S1630, the computing system 130 may identify, based on a plurality of inefficiency indices and the plurality of characteristic indices, at least one piece of abnormal equipment among the plurality of pieces of equipment.

As shown in FIG. 16, the computing system 130 may identify abnormal equipment not only by using an inefficiency index of the equipment, but also by using a characteristic index of the equipment, which is calculated based on a PPID similarity, together with the inefficiency index of the equipment, thereby identifying the abnormal equipment more accurately.

In detail, by using the characteristic index of the equipment together with the inefficiency index of the equipment, the computing system 130 may more accurately identify inefficiency caused by “detailed errors in PPID group settings.”

For example, even in a case where a PPID of a preceding process operation and a PPID of a subsequent process operation are similar so that performing a non-process operation is not necessary, a characteristic index value of the equipment may increase when a non-process operation is performed. Also, in a case where a PPID of a preceding process operation and a PPID of a subsequent process operation are dissimilar so that performing a non-process operation is necessary, a characteristic index value of the equipment may decrease when a non-process operation is performed. As such, by using a “characteristic index of equipment,” which quantifies whether performing of a non-process operation is efficient or inefficient based on a similarity between a preceding PPID and a subsequent PPID, together with an “inefficiency index of equipment,” “detailed errors in PPID group settings” of abnormal equipment may be more accurately identified.

FIG. 17 illustrates examples of an operation flowchart and a PPID of equipment according to some embodiments.

Referring to FIG. 17, the computing system 130 may extract five operations from history data 2310-1 of first equipment and may classify each operation as a process operation or a non-process operation. An operation flowchart 1700 illustrated in FIG. 17 is a flowchart showing operations performed over time t, and may represent results of extracting a first process operation 1710-1, a second process operation 1710-2, a third process operation 1710-3, a first non-process operation 1720-1, and a second non-process operation 1720-2 from the history data 2310-1 of the first equipment.

The computing system 130 may identify, based on the operation classification result, operations classified as non-process operations from the history data 2310-1 of the first equipment. For example, the computing system 130 may identify the first non-process operation 1720-1 and the second non-process operation 1720-2. A method by which the computing system 130 distinguishes between a process operation and a non-process operation has been described above, and thus, a detailed description thereof is omitted.

The computing system 130 may identify a preceding PPID and a subsequent PPID for each of all non-process operations included in the history data 2310-1 of the first equipment. In detail, the computing system 130 may identify a PPID of a process operation performed prior to each of all non-process operations included in the history data 2310-1 of the first equipment as a preceding PPID, and may identify a PPID of a process operation performed subsequent to each of all non-process operations included in the history data 2310-1 of the first equipment as a subsequent PPID.

For example, because the process operation performed prior to the first non-process operation 1720-1 is the first process operation 1710-1, the computing system 130 may identify a first PPID (PPID 1), which is a PPID of the first process operation 1710-1, as a preceding PPID of the first non-process operation 1720-1. In addition, because the process operation performed subsequent to the first non-process operation 1720-1 is the second process operation 1710-2, the computing system 130 may identify a second PPID (PPID 2), which is a PPID of the second process operation 1710-2, as a subsequent PPID of the first non-process operation 1720-1.

In addition, based on the same method, the computing system 130 may identify a preceding PPID for the second non-process operation 1720-2 as the second PPID (PPID 2), and may identify a succeeding PPID for the second non-process operation 1720-2 as a third PPID (PPID 3).

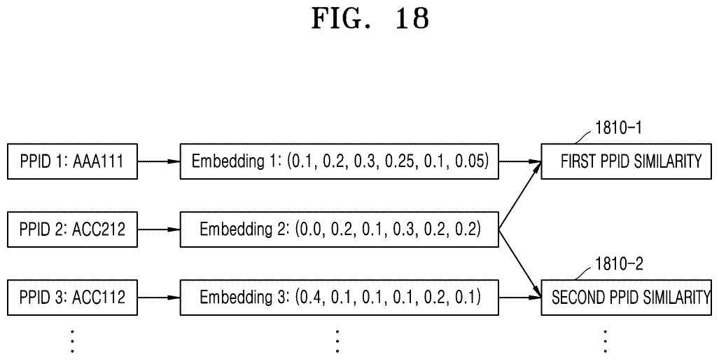

The computing system 130 may identify PPID similarities between the preceding PPID and the subsequent PPID for each of all non-process operations included in the history data 2310-1 of the first equipment. This aspect will be described in detail below in the description of FIG. 18.

FIG. 17 only illustrates a method by which the computing system 130 identifies a preceding PPID and a subsequent PPID based on the history data 2310-1 of the first equipment, but this is only an example. Based on the same principle, the computing system 130 may also identify a preceding PPID and a subsequent PPID based on history data of the second equipment 110-2, history data of the third equipment 110-3, . . . , and history data of the M-th equipment 110-M.

FIG. 18 is a diagram illustrating an example of an operation of identifying a PPID similarity, according to some embodiments.

Referring to FIG. 18, the computing system 130 may convert a preceding PPID and a subsequent PPID into a preceding embedding and a subsequent embedding, respectively, may calculate a vector similarity between the preceding embedding and the subsequent embedding, and may identify the calculated vector similarity as a PPID similarity between the preceding PPID and the subsequent PPID.

As in FIG. 17, the computing system 130 may identify a preceding PPID of the first non-process operation 1720-1 as the first PPID (PPID 1) and a subsequent PPID of the first non-process operation 1720-1 as the second PPID (PPID 2). The computing system 130 may identify a first PPID similarity 1810-1 between the first PPID (PPID 1), which is a preceding PPID, and the second PPID (PPID 2), which is a subsequent PPID.

In some embodiments, the computing system 130 may convert the first PPID (PPID 1) into a first embedding (Embedding 1) and may convert the second PPID (PPID 2) into a second embedding (Embedding 2). Here, an operation of the computing system 130 to convert a “PPID” into an “embedding” may be performed based on an embedding model.

The embedding model may be a model trained to, when a plurality of PPIDs including the same/similar structures and the same/similar characters are input, convert the input plurality of PPIDs into the same/similar embeddings. The embedding model may be implemented as various models that may receive a string and output an embedding, such as a Word2Vec model, a Glo Ve model, and a BERT model.

Here, a PPID may be a string in which a plurality of alphabets and a plurality of numbers are arranged according to rules determined by a user (e.g., an engineer). The PPID may include detailed information about a process operation performed in the corresponding equipment. For example, the PPID may include a plurality of items of detailed information about a process operation, such a final target product of a wafer subject to the process operation, and a step in which the process operation is performed. In other words, the PPID may be a string including detailed information about a process operation, and the string may include a plurality of alphabets and a plurality of numbers arranged according to rules defined by a user of process equipment.

The computing system 130 may identify a vector similarity between the first embedding (Embedding 1) and the second embedding (Embedding 2). For example, the vector similarity between the first embedding (Embedding 1) and the second embedding (Embedding 2) may be identified by a method of identifying a cosine similarity between the first embedding (Embedding 1) and the second embedding (Embedding 2). However, a method of identifying a vector similarity is not limited to a method of identifying a cosine similarity, and may be performed based on various methods.

The computing system 130 may identify the vector similarity between the first embedding (Embedding 1) and the second embedding (Embedding 2) as the first PPID similarity 1810-1 for the first non-process operation 1720-1. The computing system 130 may identify a second PPID similarity 1810-2 for the second non-process operation 1720-2 based on the same method.

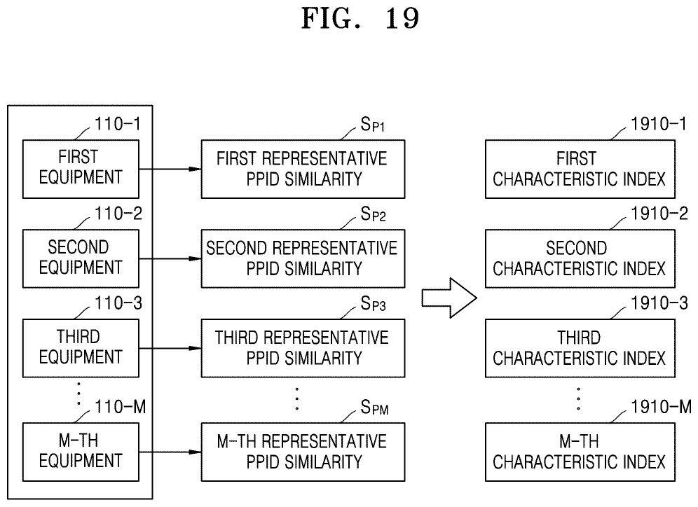

Although FIG. 18 illustrates an operation of the computing system 130 to identify the first PPID similarity 1810-1 and the second PPID similarity 1810-2, the computing system 130 may also identify PPID similarities for all non-process operations included in the history data 2310-1 of the first equipment. For example, when there are a total of 100 non-process operations included in the history data 2310-1 of the first equipment, the computing system 130 may identify all PPID similarities from the first PPID similarity 1810-1 to a 100th PPID similarity. The computing system 130 may identify a plurality of PPID similarities from the history data 2310-1 of the first equipment and may identify a representative PPID similarity based on the plurality of PPID similarities. This aspect will be described in detail below in the description of FIG. 19.

FIG. 19 is a diagram illustrating an example of an operation of calculating a characteristic index, according to some embodiments.

Referring to FIG. 19, the computing system 130 may identify a plurality of representative PPID similarities (e.g., a first representative PPID similarity SP1, a second representative PPID similarity SP2, a third representative PPID similarity SP3, . . . , and an M-th representative PPID similarity SPM) respectively corresponding to a plurality of pieces of equipment 110-1, 110-2, . . . 110-M. In addition, the computing system 130 may identify, based on the plurality of representative PPID similarities, a plurality of characteristic indices (e.g., a first characteristic index 1910-1, a second characteristic index 1910-2, a third characteristic index 1910-3, . . . , and an M-th characteristic index 1910-M) respectively corresponding to the plurality of pieces of equipment 110-1, 110-2, . . . 110-M.

For example, as described in the description of FIG. 18, the computing system 130 may identify a plurality of PPID similarities from the history data 2310-1 of the first equipment. The computing system 130 may identify a first representative PPID similarity SP1 of the first equipment 110-1 based on the plurality of PPID similarities identified from the history data 2310-1 of the first equipment. In detail, the first representative PPID similarity SP1 may be the mean value or median value of the plurality of PPID similarities identified from the history data 2310-1 of the first equipment. However, the first representative PPID similarity SP1 is not limited to the mean value or median value of the plurality of PPID similarities identified from the history data 2310-1 of the first equipment 110-1, and may be implemented as various types of statistical values that may represent the plurality of PPID similarities. Based on the same method, the computing system 130 may identify a second representative PPID similarity SP2 of the second equipment 110-2, a third representative PPID similarity SP3 of the third equipment 110-3, . . . , and an M-th representative PPID similarity SPM of the M-th equipment 110-M.

The computing system 130 may identify (or determine) a plurality of characteristic indices respectively corresponding to the plurality of pieces of equipment by comparing the identified plurality of representative PPID similarities with each other.

For example, the computing system 130 may identify a maximum value and a minimum value among the plurality of representative PPID similarities by comparing the plurality of representative PPID similarities with each other. The computing system 130 may normalize the plurality of representative PPID similarities based on the maximum value and the minimum value. In other words, the computing system 130 may identify values of the plurality of representative PPID similarities, which are normalized based on Equation 2 below, as a plurality of characteristic indices, respectively.

$$Index {2}_{{P}_{j}} = \frac{{S}_{{P}_{j}} - min ( {S}_{P 1} , {S}_{P 2} , {S}_{P 3} , … , {S}_{P M} )}{max ( {S}_{P 1} , {S}_{P 2} , {S}_{P 3} , … , {S}_{P M} ) - min ( {S}_{P 1} , {S}_{P 2} , {S}_{P 3} , … , {S}_{P M} )} \qquad [ Equation 2 ]$$

Here, Index 2_{P}_{ⱼ} may refer to a characteristic index calculated for equipment Pⱼ. The max function may refer to a function for outputting the largest value among the values included in the parentheses, and the minimum (min) function may refer to a function for outputting the smallest value among the values included in the parentheses.

However, the above-described example is only an example of identifying a plurality of characteristic indices respectively corresponding to the plurality of pieces of equipment, and a method of identifying a plurality of characteristic indices is not limited to thereto. The computing system 130 may identify a plurality of characteristic indices based on the values of the plurality of representative PPID similarities through various types of methods.

For example, the computing system 130 may normalize the plurality of representative PPID similarities based on a Z-Score normalization method and may identify the plurality of representative PPID similarities normalized based on the Z-Score normalization method as a plurality of characteristic indices, respectively. In another example, the computing system 130 may identify the values of the plurality of representative PPID similarities as a plurality of characteristic indices, respectively, without using a normalization method.

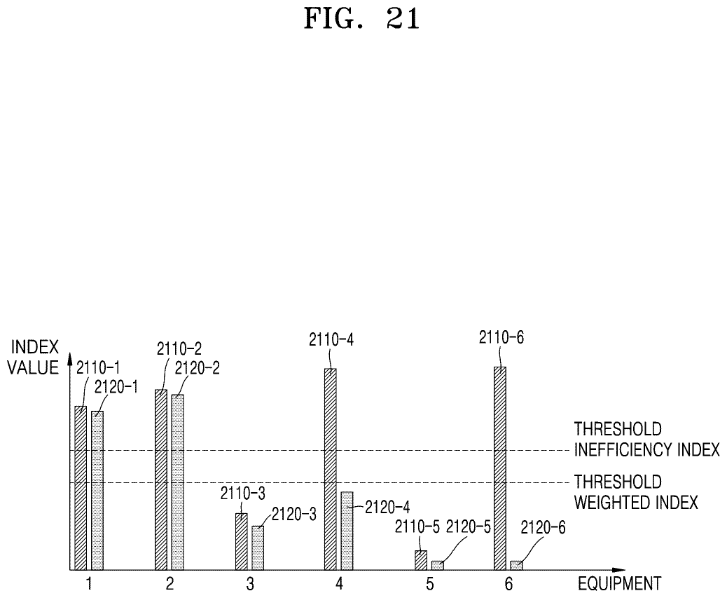

As described above, after identifying a plurality of characteristic indices respectively corresponding to the plurality of pieces of equipment, the computing system 130 may identify at least one piece of abnormal equipment among the plurality of pieces of equipment based on a plurality of inefficiency indices and the plurality of characteristic indices. This aspect will be described in detail below in the description of FIGS. 20 and 21.

FIG. 20 is a diagram illustrating an example of an operation of determining a weighted index of equipment, according to some embodiments, and FIG. 21 is a graph illustrating an example of an operation of identifying abnormal equipment, according to some embodiments.

Referring to FIG. 20, the computing system 130 may determine a plurality of weighted indices (e.g., a first weighted index 2010-1, a second weighted index 2010-2, a third weighted index 2010-3, . . . , and an M-th weighted index 2010-M) respectively corresponding to a plurality of pieces of equipment (e.g., the first equipment 110-1, the second equipment 110-2, the third equipment 110-3, . . . , and the M-th equipment 110-M).

As described above with reference to FIG. 10, the computing system 130 may identify or determine the first inefficiency index 1010-1 of the first equipment 110-1. In addition, as described above with reference to FIG. 19, the computing system 130 may identify or determine the first characteristic index 1910-1 of the first equipment 110-1. The computing system 130 may identify or determine a first weighted index 2010-1 corresponding to first equipment 110-1, based on the first inefficiency index 1010-1 and the first characteristic index 1910-1.

For example, the computing system 130 may determine or identify the first weighted index 2010-1 by multiplying the first inefficiency index 1010-1 by the first characteristic index 1910-1. In detail, a method by which the computing system 130 determines a plurality of weighted indices respectively corresponding to the plurality of pieces of equipment may be expressed as Equation 3 below.

$$Index {3}_{{P}_{j}} = Index {1}_{{P}_{j}} \times Index {2}_{{P}_{j}} \qquad [ Equation 3 ]$$

Here, Index 1_{P}_{ⱼ} may refer to an inefficiency index calculated for equipment Pⱼ, and Index 2_{P}_{ⱼ} may refer to a characteristic index calculated for the equipment Pⱼ. In addition, Index 3_{P}_{ⱼ} may refer to a weighted index calculated for the equipment Pⱼ.

However, a method by which the computing system 130 identifies a weighted index corresponding to each piece of equipment is not limited to the above-described example, and the computing system 130 may identify a weighted index corresponding to each piece of equipment based on an inefficiency index and a characteristic index through various types of methods.

For example, the computing system 130 may normalize a plurality of inefficiency indices (e.g., the first inefficiency index 1010-1, the second inefficiency index 1010-2, the third inefficiency index 1010-3, . . . , and the M-th inefficiency index 1010-M) by comparing the plurality of inefficiency indices with each other, and may normalize, to the same range as the “normalized plurality of inefficiency indices,” a plurality of characteristic indices (e.g., the first characteristic index 1910-1, the second characteristic index 1910-2, the third characteristic index 1910-3, . . . , and the M-th characteristic index 1910-M) by comparing the plurality of characteristic indices with each other.

In a detailed example, the computing system 130 may normalize a plurality of inefficiency indices through max-min normalization, and may also normalize a plurality of characteristic indices through max-min normalization. In this case, the plurality of inefficiency indices may be normalized in a range of 0 to 1, and the plurality of characteristic indices may also be normalized in a range of 0 to 1. However, a method by which the computing system 130 normalizes a plurality of inefficiency indices and a plurality of characteristic indices within the same range is not limited to a max-min normalization method, and various types of normalization methods may be applied.

The computing system 130 may identify a plurality of weighted indices respectively corresponding to the plurality of pieces of equipment by respectively weight-averaging the plurality of inefficiency indices and the plurality of characteristic indices, which have been normalized within the same range. In detail, a method of identifying a plurality of weighted indices by respectively weight-averaging the normalized plurality of inefficiency indices and the normalized plurality of characteristic indices may be expressed as Expression 4 below.

$$Index {3}_{{P}_{j}} = {w}_{1} \times N = Index {1}_{{P}_{j}} + {w}_{2} \times N - Index {2}_{{P}_{j}} \qquad [ Equation 4 ]$$

Here, N-Index 1_{P}_{ⱼ} may refer to a normalized inefficiency index calculated for equipment Pⱼ, N-Index 2_{P}_{ⱼ} may refer to a normalized characteristic index calculated for the equipment Pⱼ, and Index 3_{P}_{ⱼ} may refer to a weighted index calculated for the equipment Pⱼ. In addition, w₁ may refer to a weight for the inefficiency index, and w₂ may refer to a weight for the characteristic index. Values of w₁ and w₂ may be determined by a user, and when w₁ is greater than w₂, the inefficiency index may serve as a more important index for detecting abnormal equipment than the characteristic index. When w₂ is greater than w₁, the characteristic index may serve as a more important index for detecting abnormal equipment than the inefficiency index.

FIG. 21 illustrates a plurality of bar graphs showing values of an inefficiency index and a weighted index of each of first through sixth equipment 110-1, . . . , and 110-6. Inefficiency index values shown in the bar graphs of FIG. 21 are calculated based on Equation 1, and weighted index values shown in the bar graphs of FIG. 21 are calculated based on Equation 3.

A first inefficiency index bar graph 2110-1, a second inefficiency index bar graph 2110-2, a third inefficiency index bar graph 2110-3, a fourth inefficiency index bar graph 2110-4, a fifth inefficiency index bar graph 2110-5, and a sixth inefficiency index bar graph 2110-6 respectively represent inefficiency index values of the first through sixth equipment 110-1, . . . , and 110-6. In addition, a first weighted index bar graph 2120-1, a second weighted index bar graph 2120-2, a third weighted index bar graph 2120-3, a fourth weighted index bar graph 2120-4, a fifth weighted index bar graph 2120-5, and a sixth weighted index bar graph 2120-6 respectively represent weighted index values of the first through sixth equipment 110-1, . . . , and 110-6. In addition, a threshold inefficiency index value may be determined based on the method described above in the description of FIG. 10.

As shown in FIG. 21, the first inefficiency index bar graph 2110-1, the second inefficiency index bar graph 2110-2, the fourth inefficiency index bar graph 2110-4, and the sixth inefficiency index bar graph 2110-6 exceed the threshold inefficiency index. When the computing system 130 identifies abnormal equipment based only on the inefficiency index of each piece of equipment, the first equipment 110-1, the second equipment 110-2, the fourth equipment 110-4, and the sixth equipment 110-6 may be identified as abnormal equipment. However, the computing system 130 may identify at least one piece of abnormal equipment among the plurality of pieces of equipment based on a weighted index value that reflects both the inefficiency index value and the characteristic index value of each of the plurality of pieces of equipment.

For example, the computing system 130 may calculate or identify a threshold weighted index based on a plurality of weighted indices respectively corresponding to the plurality of pieces of equipment. The computing system 130 may determine a weighted index that exceeds the threshold weighted index as an outlier. The computing system 130 may identify equipment having a weighted index being an outlier as abnormal equipment.

For example, the threshold weighted index may be determined based on the distribution of weighted indices of the plurality of pieces of equipment (e.g., the first equipment 110-1, the second equipment 110-2, the third equipment 110-3, . . . , and the M-th equipment 110-M). For a non-limiting example, the computing system 130 may determine a value obtained by adding three times the standard deviation of the weighted indices of the plurality of pieces of equipment to the average of the weighted indices of the plurality of pieces of equipment as the threshold weighted index. For a non-limiting example, the computing system 130 may determine a value obtained by adding 1.5 times the interquartile range of the weighted indices of the plurality of pieces of equipment to the third quartile of the weighted indices of the plurality of pieces of equipment as the threshold weighted index.

As shown in FIG. 21, the first weighted index bar graph 2120-1 and the second weighted index bar graph 2120-2 exceed the threshold weighted index. Accordingly, the computing system 130 may identify the weighted index of the first equipment 110-1 and the weighted index of the second equipment 110-2 as weighted indices being outliers, and may identify the first equipment 110-1 and the second equipment 110-2 as abnormal equipment. In contrast, the computing system 130 may not identify the fourth equipment 110-4 and the fifth equipment 110-5 as abnormal equipment, based on the weighted indices of the fourth equipment 110-4 and the fifth equipment 110-5.

In other words, based on a weighted index reflecting a similarity between a preceding PPID and a subsequent PPID, the computing system 130 may identify the first equipment 110-1 and the second equipment 110-2, in which detailed errors in PPID group settings exist, as abnormal equipment, but may not identify the fourth equipment 110-4 and the fifth equipment 110-5, in which no errors in PPID group settings exist, as abnormal equipment.

As described above, by identifying abnormal equipment based on the weighted index, the computing system 130 may more accurately identify whether detailed errors exist in PPID group settings of the corresponding equipment.

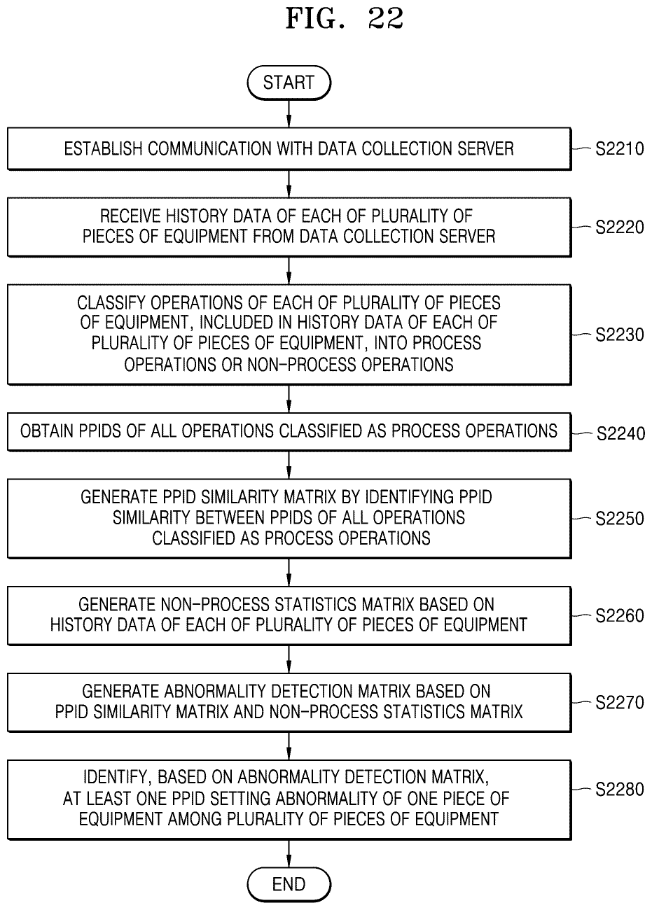

FIG. 22 is a flowchart illustrating an example of an operation of identifying a PPID setting abnormality of equipment, according to some embodiments.

Referring to FIG. 22, in operation S2210, the computing system 130 may establish communication with the data collection server 120.

In operation S2220, the computing system 130 may receive history data of each of a plurality of pieces of equipment from the data collection server 120.

In operation S2230, the computing system 130 may classify operations of each of the plurality of pieces of equipment, which are included in the history data of each of the plurality of pieces of equipment, into process operations or non-process operations.

In operation S2240, the computing system 130 may obtain PPIDs of all operations classified as the process operations. In detail, the computing system 130 may obtain the PPIDs of all operations from the history data of each of the plurality of pieces of equipment.

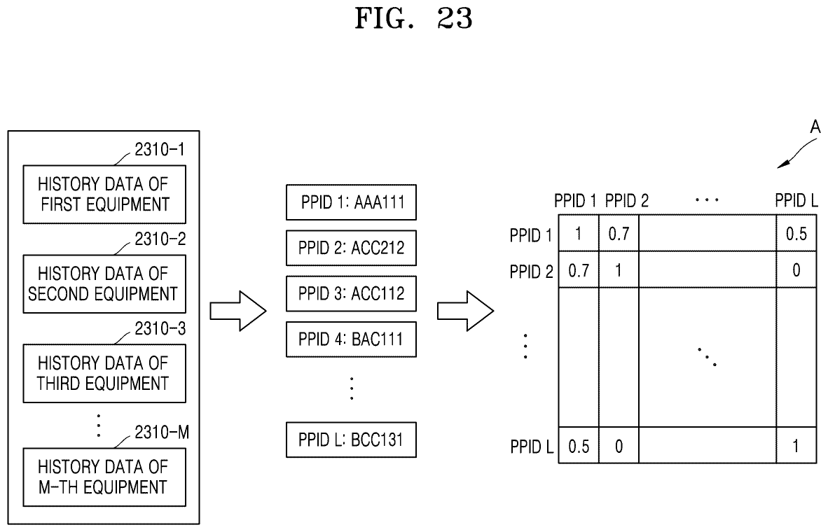

In operation S2250, the computing system 130 may generate a PPID similarity matrix by identifying a PPID similarity between the PPIDs of all operations classified as the process operations. The term “PPID similarity matrix” may refer to a matrix in which PPID similarities between PPIDs of all process operations included in the history data of each of the plurality of pieces of equipment are arranged along a plurality of rows and a plurality of columns. The PPID similarity matrix will be described in detail below in the description of FIG. 23.

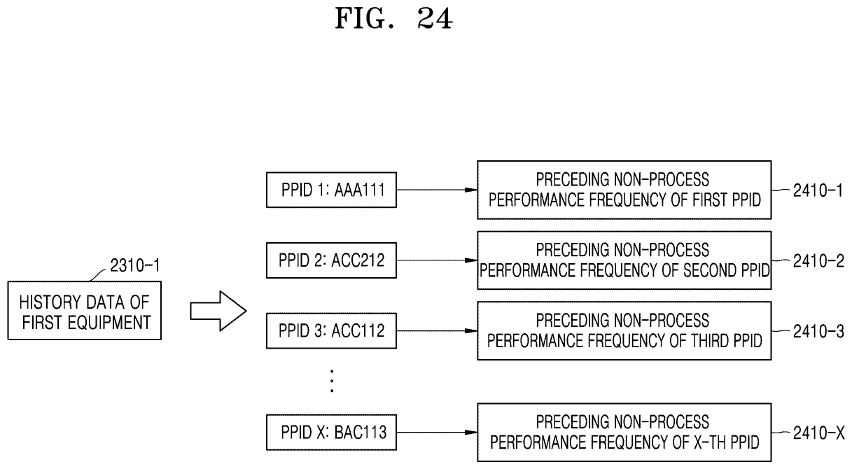

In operation S2260, the computing system 130 may generate a non-process statistics matrix based on the history data of each of the plurality of pieces of equipment. Here, the term “non-process statistics matrix” may refer to a matrix including, for each of the plurality of pieces of equipment, information about the performance frequency of a non-process operation performed prior to each of all process operations included in the history data. The non-process statistics matrix will be described in detail below in the description of FIGS. 24 to 26.

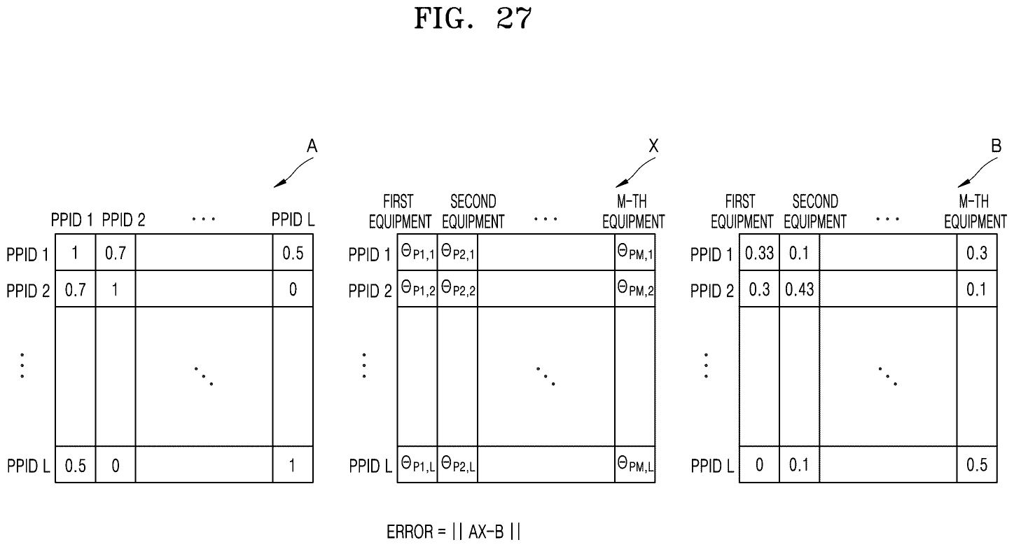

In operation S2270, the computing system 130 may generate an abnormality detection matrix based on the PPID similarity matrix and the non-process statistics matrix. Here, the term “abnormality detection matrix” may refer to a matrix including information about errors in PPID group settings. In detail, the abnormality detection matrix may include a plurality of detection parameters arranged along a plurality of rows and a plurality of columns, and may be a parameter for classifying, for each of the plurality of pieces of equipment, the probability that each of the plurality of PPIDs is in an abnormal setting state. Here, the expression “a specific PPID is in an abnormal setting state” may indicate that “errors exist in PPID group settings of the specific PPID.” The abnormality detection matrix will be described in detail below in the description of FIG. 27.

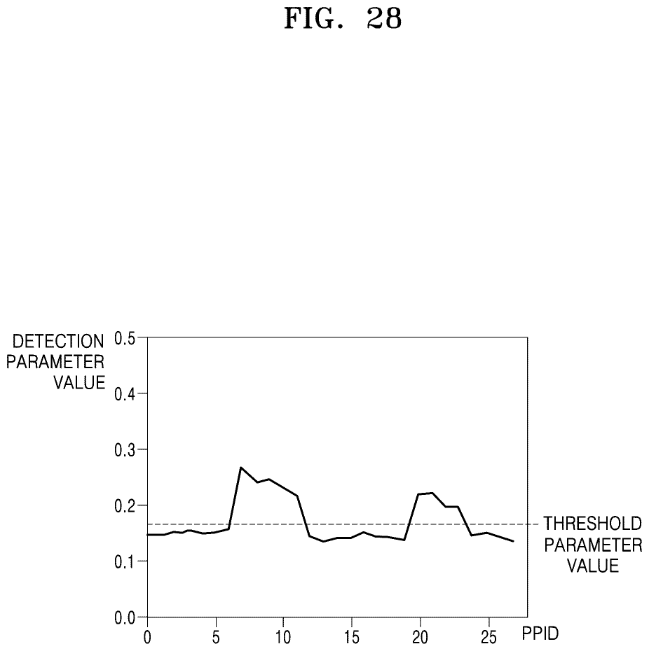

In operation S2280, the computing system 130 may identify, based on the abnormality detection matrix, at least one PPID setting abnormality of one piece of equipment among the plurality of pieces of equipment. A method by which the computing system 130 identifies a PPID setting abnormality based on an abnormality detection matrix will be described in detail below in the description of FIG. 28.

The computing system 130 may identify at least one PPID setting abnormality of one piece of equipment by performing the operations described above. As a result, a user may specify a PPID in which errors in PPID group settings exist, and may take prompt action on the specified PPID to eliminate an abnormality of the equipment.

FIG. 23 is a diagram illustrating an example of an operation of generating a PPID similarity matrix, according to some embodiments.

Referring to FIG. 23, the computing system 130 may obtain or identify a plurality of PPIDs (e.g., a first PPID (PPID 1), a second PPID (PPID 2), a third PPID (PPID 3), a fourth PPID (PPID 4), . . . , and an L-th PPID (PPID L)) (where L is a natural number greater than or equal to 4) of all process operations included in history data of each of a plurality of pieces of equipment (e.g., history data 2310-1 of first equipment, history data 2310-2 of second equipment, history data 2310-3 of third equipment, . . . , and history data 2310-M of M-th equipment), from the history data.

The computing system 130 may identify similarities between the plurality of PPIDs and arrange the identified similarities between the plurality of PPIDs along a plurality of rows and a plurality of columns to generate a PPID similarity matrix A.

For example, the computing system 130 may convert the plurality of PPIDs into a plurality of embeddings, respectively. Here, an operation of the computing system 130 to convert the plurality of PPIDs into a plurality of embeddings, respectively, may be performed based on an embedding model.

The embedding model may be a model trained to, when a plurality of PPIDs including the same/similar structures and the same/similar characters are input, convert the input plurality of PPIDs into the same/similar embeddings. The embedding model may be implemented as various models that may receive a string and output an embedding, such as a Word2Vec model, a GloVe model, and/or a BERT model.

An operation of converting the plurality of PPIDs into a plurality of embeddings, respectively, overlaps that described above in the description of FIG. 18, and thus, a detailed description thereof is omitted.

After converting the plurality of PPIDs into the plurality of embeddings, respectively, the computing system 130 may identify a vector similarity between the plurality of embeddings. A method of identifying a vector similarity may be performed based on the method of identifying a cosine similarity.

For example, the computing system 130 may convert the first PPID (PPID 1) and the second PPID (PPID 2) into a first embedding and a second embedding, respectively, and may identify a cosine similarity between the first embedding and the second embedding. The computing system 130 may identify the cosine similarity between the first embedding and the second embedding as a similarity between the first PPID (PPID 1) and the second PPID (PPID 2). The computing system 130 may identify all similarities between the plurality of PPIDs based on the same principle.

The computing system 130 may generate a PPID similarity matrix A by arranging similarities between the plurality of PPIDs along a plurality of rows and a plurality of columns.

The PPID similarity matrix A may be a square matrix with the same number of rows and columns.

The number of rows and the number of columns of the PPID similarity matrix A may be equal to the number of PPIDs of all process operations extracted from the history data of each of the plurality of pieces of equipment. For example, when the number of PPIDs of all process operations extracted from the history data of each of the plurality of pieces of equipment by the computing system 130 is 100 (L=100), the PPID similarity matrix A may be a square matrix with 100 rows and 100 columns.

For example, as shown in FIG. 23, all components of the PPID similarity matrix A may have values in a range of 0 to 1. That is, a similarity between the plurality of PPIDs may have a value in a range of 0 to 1. The closer the similarity value between PPIDs is to 0, the smaller the similarity between two PPIDs, and the closer the similarity value between PPIDs is to 1, the greater the similarity between two PPIDs.

All values of diagonal components (components with the same number of indices in rows and columns) of the PPID similarity matrix A may be 1. In other words, as shown in FIG. 23, when components of a first row to an L-th row are listed in the order of the first PPID (PPID 1) to the L-th PPID (PPID L) and components of a first column to an L-th column are listed in the order of the first PPID (PPID 1) to the L-th PPID (PPID L) (that is, when rows and columns are arranged according to the same PPID order), a diagonal component of the PPID similarity matrix A, which represents a similarity between identical PPIDs, may have a value of 1.

However, the above-described arrangement of the PPID similarity matrix A is only an example, and the plurality of rows and the plurality of columns of the PPID similarity matrix A may be arranged according to various orders and rules.

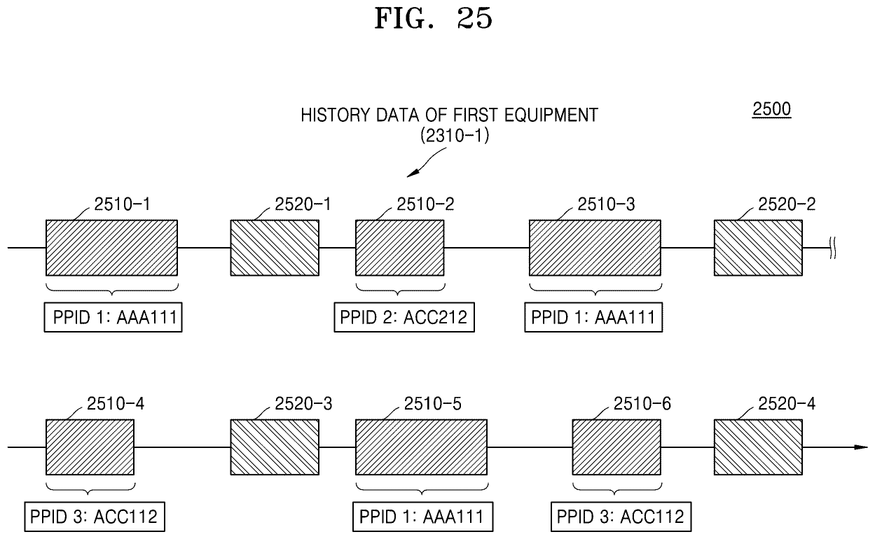

FIG. 24 is a diagram illustrating an example of an operation of identifying a preceding non-process performance frequency, according to some embodiments. FIG. 25 illustrates examples of an operation flowchart and PPID of equipment according to some embodiments.

Referring to FIG. 24, the computing system 130 may identify, for each of a plurality of pieces of equipment, a preceding non-process performance frequency of each of a plurality of PPIDs (e.g. a preceding non-process performance frequency 2410-1 of a first PPID, a preceding non-process performance frequency 2410-2 of a second PPID, a preceding non-process performance frequency 2410-3 of a third PPID, . . . , and a preceding non-process performance frequency 2410-X of an X-th PPID) from history data of each of the plurality of pieces of equipment.

In the description of FIGS. 24 and 25, a method of identifying a preceding non-process performance frequency for each PPID of a plurality of process operations included in the history data 2310-1 of the first equipment by the computing system 130 will be described as an example.

Referring to FIG. 25, the computing system 130 may extract ten operations from the history data 2310-1 of the first equipment and may classify each operation as a process operation or a non-process operation. An operation flowchart 2500 illustrated in FIG. 25 is a flowchart showing operations performed over time t, and may represent results of extracting a first process operation 2510-1, a second process operation 2510-2, a third process operation 2510-3, a fourth process operation 2510-4, a fifth process operation 2510-5, a sixth process operation 2510-6, a first non-process operation 2520-1, a second non-process operation 2520-2, a third non-process operation 2520-3, and a fourth non-process operation 2520-4 from the history data 2310-1 of the first equipment.

The computing system 130 may identify the preceding non-process performance frequency 2410-1 of the first PPID based on the operation classification result.

For example, the computing system 130 may identify the number of times a process operation of the first PPID (PPID 1) has been performed. As shown in FIG. 25, because the PPIDs of the first process operation 2510-1, the third process operation 2510-3, and the fifth process operation 2510-5 are the first PPID (PPID 1), the computing system 130 may identify that the total number of times the process operation of the first PPID (PPID 1) has been performed is 3, as non-limiting example.

The computing system 130 may identify the number of times a non-process operation has been performed prior to the process operation of the first PPID (PPID 1). As shown in FIG. 25, because the third non-process operation 2520-3 has been performed prior to the fifth process operation 2510-5 among the process operations of the first PPID (PPID 1), the computing system 130 may identify that the number of times the non-process operation has been performed prior to the process operation of the first PPID (PPID 1) is 1, as non-limiting example.

The computing system 130 may generate information about the preceding non-process performance frequency 2410-1 of the first PPID based on the number of times the process operation of the first PPID (PPID 1) has been performed and the number of times the non-process operation has been performed prior to the process operation of the first PPID (PPID 1). For example, the computing system 130 may generate information about the preceding non-process performance frequency 2410-1 of the first PPID by dividing the number of times the non-process operation has been performed prior to the process operation of the first PPID (PPID 1) by the number of times the process operation of the first PPID (PPID 1) has been performed. As described above, when the number of times the non-process operation has been performed prior to the process operation of the first PPID (PPID 1) is 1, and the number of times the process operation of the first PPID (PPID 1) has been performed is 3, the computing system 130 may calculate or identify the preceding non-process performance frequency 2410-1 of the first PPID as “⅓.”

Based on the same principle, the computing system 130 may identify the preceding non-process performance frequency 2410-2 of the second PPID as “1,” and may identify the preceding non-process performance frequency 2410-3 of the third PPID as “0.5.”

As described above, the computing system 130 may identify, for each of a plurality of PPIDs, the number of times a non-process operation has been performed prior to a process operation of each of the plurality of PPIDs, and may generate information about a preceding non-process performance frequency of each of the plurality of PPIDs, based on the identified number of times the non-process operation has been performed.

Although a case where the computing system 130 generates information about a preceding non-process performance frequency of each of a plurality of PPIDs based on the history data 2310-1 of the first equipment has been described above, based on the same principle, the computing system 130 may generate information about a preceding non-process performance frequency of each of a plurality of PPIDs based on each of the history data 2310-2, . . . , and 2310-M of the second through M-th equipment.

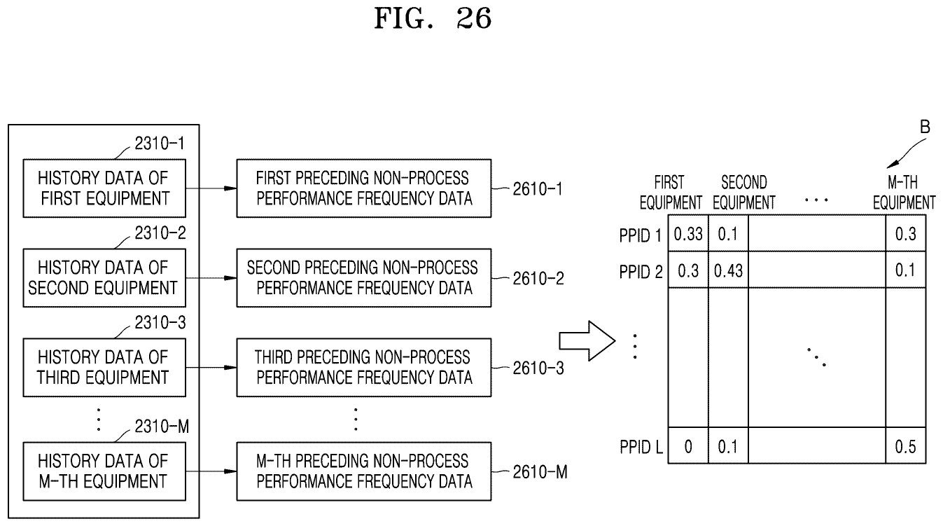

The computing system 130 may generate a non-process statistics matrix B based on information about the preceding non-process performance frequency. A method of generating the non-process statistics matrix B will be described in detail below in the description of FIG. 26.

FIG. 26 is a diagram illustrating an example of an operation of generating a non-process statistics matrix, according to some embodiments.

Referring to FIG. 26, the computing system 130 may generate a non-process statistics matrix B based on a plurality of items of preceding non-process performance frequency data (e.g., first preceding non-process performance frequency data 2610-1, second preceding non-process performance frequency data 2610-2, third preceding non-process performance frequency data 2610-3, . . . , and M-th preceding non-process performance frequency data 2610-M) generated from respective history data of a plurality of pieces of equipment (e.g., history data 2310-1 of first equipment, history data 2310-2 of second equipment, history data 2310-3 of third equipment, . . . , and history data 2310-M of M-th equipment).

The computing system 130 may generate the non-process statistics matrix B by arranging the plurality of items of preceding non-process performance frequency data along a plurality of rows and a plurality of columns.

Here, the first preceding non-process performance frequency data 2610-1 may include information about non-process performance frequencies of a plurality of PPIDs generated from the history data 2310-1 of the first equipment. In detail, referring back to FIG. 24, the first preceding non-process performance frequency data 2610-1 may include information about the preceding non-process performance frequency 2410-1 of the first PPID, the preceding non-process performance frequency 2410-2 of the second PPID, the preceding non-process performance frequency 2410-3 of the third PPID, . . . , and the preceding non-process performance frequency 2410-X of the X-th PPID.

In addition, the second preceding non-process performance frequency data 2610-2 through the M-th preceding non-process performance frequency data 2610-M may include information about preceding non-process performance frequencies of a plurality of PPIDs generated from each of the history data 2310-2 of the second equipment through the history data 2310-M of the M-th equipment.

The computing system 130 may generate the non-process statistics matrix B by mapping a plurality of columns to the plurality of pieces of equipment, respectively, and mapping a plurality of rows to the plurality of PPIDs, respectively. In this case, the number of the plurality of columns may be equal to the number of the plurality of pieces of equipment, and the number of the plurality of rows may be equal to the number of the plurality of PPIDs. As described above in the description of FIG. 23, because the PPIDs of all process operations included in the history data of the plurality of pieces of equipment are the first PPID (PPID 1) to the L-th PPID (PPID L), the total number of the plurality of PPIDs may be L. Accordingly, as shown in FIG. 26, the number of the plurality of columns of the non-process statistics matrix B may be M, and the number of the plurality of rows of the non-process statistics matrix B may be L.

The computing system 130 may sequentially arrange the plurality of items of preceding non-process performance frequency data respectively generated for the plurality of pieces of equipment in the plurality of columns respectively mapped to the plurality of pieces of equipment, and may generate the non-process statistics matrix B by arranging a value of “0” for a PPID that has not been included in the history data of each piece of equipment.

For example, the computing system 130 may set values of components of a first column of the non-process statistics matrix B based on the first preceding non-process performance frequency data 2610-1 generated from the history data 2310-1 of the first equipment. As described above with reference to FIGS. 24 and 25, because the preceding non-process performance frequency 2410-1 of the first PPID is “0.333 . . . ” and the preceding non-process performance frequency 2410-2 of the second PPID is “1,” the computing system 130 may set a value of a component of a row corresponding to the first PPID (PPID 1), among the components of the first column of the non-process statistics matrix B, to “0.333 . . . ,” and may set a value of a component of a row corresponding to the second PPID (PPID 2), among the components of the first column of the non-process statistics matrix B, to “1.” In addition, because the L-th PPID (PPID L) is a PPID that has not been included in the history data 2310-1 of the first equipment, the computing system 130 may set a value of a component of a row corresponding to the L-th PPID (PPID L), among the components of the first column of the non-process statistics matrix B, to “0”.

Based on the same method as the above-described example, the computing system 130 may set values of components of the plurality of columns of the non-process statistics matrix B, which respectively correspond to the plurality of pieces of equipment, based on the plurality of items of preceding non-process performance frequency data, and may generate the non-process statistics matrix B.

The computing system 130 may generate an abnormality detection matrix X based on the PPID similarity matrix A and the non-process statistics matrix B that have been generated, and this aspect will be described in detail below in the description of FIG. 27.

FIG. 27 is a diagram illustrating an example of an operation of generating an abnormality detection matrix X, according to some embodiments.

Referring to FIG. 27, the computing system 130 may generate an abnormality detection matrix X based on the PPID similarity matrix A and the non-process statistics matrix B.

Here, the abnormality detection matrix X may include a plurality of detection parameters. The plurality of detection parameters may each be a parameter for classifying, for each of the plurality of pieces of equipment, the probability that each of the plurality of PPIDs is in an abnormal setting state. As shown in FIG. 27, the plurality of detection parameters may include detection parameters (θ_{P1,1}, θP_{1,2}, . . . , and θ_{P1,L}) of first equipment and detection parameters (θ_{P2, 1}, θ_{P2,2}, . . . , and θP_{2,L}) of second equipment through detection parameters (θ_{PM,1}, θ_{PM,2}, . . . , and θ_{PM,L}) of M-th equipment. In detail, the detection parameter (θ_{P1,1}) may represent the probability that the first PPID (PPID 1) in the first equipment 110-1 is in the abnormal setting state, and the detection parameter (θ_{PM,L}) may represent the probability that the L-th PPID (PPID L) in the M-th equipment 110-M is in the abnormal setting state.

The computing system 130 may assign random values to values of all components included in the abnormality detection matrix X. Subsequently, the computing system 130 may identify an error (ERROR) between a matrix product AX of the PPID similarity matrix A and the abnormality detection matrix X and the non-process statistics matrix B. For example, as shown in FIG. 27, the computing system 130 may calculate a difference between the matrix product AX and the non-process statistics matrix B, and may identify the norm value of the difference as the error (ERROR).

In another example, the computing system 130 may calculate a difference between the matrix product AX and the non-process statistics matrix B, and may identify the square of the norm value of the difference as the error (ERROR).

However, a method by which the computing system 130 identifies the error (ERROR) between the matrix product AX and the non-process statistics matrix B is not limited to the above-described examples, and the error (ERROR) between the matrix product AX and the non-process statistics matrix B may be identified based on a method suitable for optimizing the plurality of detection parameters included in the abnormality detection matrix X.

The computing system 130 may identify a plurality of parameters for minimizing the identified error (ERROR), and may identify the identified plurality of parameters as the plurality of detection parameters of the abnormality detection matrix X.

For example, the computing system 130 may identify values of the plurality of detection parameters constituting the abnormality detection matrix X, based on Equation 5 below.

$$X = \begin{matrix}arg min \\ X\end{matrix} ‖ A X - B {‖}^{2} \qquad [ Equation 5 ]$$

Equation 5 may be an equation representing a method of optimizing the abnormality detection matrix X when the error (ERROR) between the matrix product AX and the non-process statistics matrix B is defined as the square of the norm value of the difference between the matrix product AX and the non-process statistics matrix B.

However, Equation 5 is an example showing a method of optimizing the abnormality detection matrix X, and the method of optimizing the abnormality detection matrix X is not limited to the above-described example.

For example, when the error (ERROR) between the matrix product AX and the non-process statistics matrix B is defined as the norm value of the difference between the matrix product AX and the non-process statistics matrix B, the abnormality detection matrix X may be optimized through a method of identifying the abnormality detection matrix X, in which the norm value of the difference between the matrix product AX and the non-process statistics matrix B is minimized.

As described above, the computing system 130 may generate the abnormality detection matrix X based on the PPID similarity matrix A and the non-process statistics matrix B. In addition, the computing system 130 may identify a PPID setting abnormality of one piece of equipment based on the abnormality detection matrix X, and this aspect will be described in detail below in the description of FIG. 28.

FIG. 28 is a diagram illustrating an example of an operation of identifying a PPID setting abnormality, according to some embodiments.

The graph of FIG. 28 is a graph showing values of the detection parameters (θ_{P1,1}, θP_{1,2}, . . . , and θ_{P1,L}) of the first equipment for each of a plurality of PPIDs. In the graph of FIG. 28, the X-axis represents a PPID, and the Y-axis represents a value of a detection parameter.

Referring to FIG. 28, the computing system 130 may identify at least one abnormal parameter by extracting detection parameters of one piece of equipment (e.g., the first equipment 110-1) from the abnormality detection matrix X and comparing the detection parameters of the one piece of equipment (e.g., the detection parameters (θ_{P1,1}, θP_{1,2}, . . . , and θ_{P1,L}) of the first equipment) with each other.

For example, the computing system 130 may identify at least one abnormal parameter based on the distribution of the detection parameters (θ_{P1,1}, θP_{1,2}, . . . , and θ_{P1,L}) of the first equipment. For example, the computing system 130 may calculate a threshold parameter value based on the detection parameters of the first equipment. The computing system 130 may determine a detection parameter that exceeds the threshold parameter value as an outlier. The computing system 130 may identify a detection parameter being an outlier as an abnormal parameter.

For example, as shown in FIG. 28, the computing system 130 may compare values of about 28 detection parameters (θ_{P1,1}, θP_{1,2}, . . . , and θ_{P1,28}) of the first equipment with the threshold parameter value. Based on a result of comparing the values of the detection parameters (θ_{P1,1}, θP_{1,2}, . . . , and θ_{P1,28}) of the first equipment with the threshold parameter value, the computing system 130 may identify at least one abnormal parameter among the detection parameters (θ_{P1,1}, θ_{P1,2}, . . . , and θ_{P1,28}) of the first equipment.

The computing system 130 may identify at least one PPID corresponding to the at least one abnormal parameter as a PPID in the abnormal setting state. For example, when an eighth PPID detection parameter (θ_{P1,8}), a ninth PPID detection parameter (θ_{P1,9}), a tenth PPID detection parameter (θ_{P1,10}) and an eleventh PPID detection parameter (θ_{P1,11}) among the detection parameters (θ_{P1,1}, θP_{1,2}, . . . , and θ_{P1,28}) of the first equipment are identified as abnormal parameters, the computing system 130 may identify an eighth PPID (PPID 8), a ninth PPID (PPID 9), a tenth PPID (PPID 10), and an eleventh PPID (PPID 11) as PPIDs in the abnormal setting state in the first equipment 110-1.

A threshold parameter value of each of the plurality of pieces of equipment may be determined based on the distribution of detection parameters of each of the plurality of pieces of equipment. For example, the computing system 130 may determine the average of the detection parameters (θ_{P1,1}, θP_{1,2}, . . . , and θ_{P1,L}) of the first equipment as the threshold parameter value of the first equipment 110-1. In another example, the computing system 130 may determine the median value of the detection parameters (θ_{P1,1}, θP_{1,2}, . . . , and θ_{P1,L}) of the first equipment as the threshold parameter value of the first equipment 110-1.

The threshold parameter value may also be determined based on the distribution of all detection parameters included in the abnormality detection matrix X. For example, the computing system 130 may determine a value obtained by adding three times the standard deviation of all detection parameters included in the abnormality detection matrix X to the average of all detection parameters as the threshold parameter value. For example, the computing system 130 may determine a value obtained by adding 1.5 times the interquartile range of all detection parameters included in the abnormality detection matrix X to the third quartile of all detection parameters as the threshold parameter value.

As described above, the computing system 130 according to some embodiments may identify abnormal equipment by using an inefficiency index of the equipment. In addition, the computing system 130 may specifically identify detailed errors in PPID group settings by using a weighted index obtained by weighting a characteristic index to the inefficiency index.

The computing system 130 according to some embodiments may identify, based on an inefficiency index identified for each time interval, a specific time interval that has caused an abnormal state of equipment. In addition, the computing system 130 may identify, based on an abnormality detection matrix X, a specific PPID setting error that has caused the abnormal state of the equipment. Accordingly, the computing system 130 may provide a user with a specific cause of the abnormal state.

While the inventive concept has been particularly shown and described with reference to embodiments thereof, it will be understood that various changes in form and details may be made therein without departing from the spirit and scope of the following claims.

What is claimed is:

1. A method, performed by a computing system, of detecting an abnormality of equipment, the computing system comprising at least one processor, a memory, and a communication circuit, the method comprising:
establishing, by the communication circuit, communication with a data collection server;
receiving, by the communication circuit, history data of each of a plurality of pieces of equipment from the data collection server;
classifying, by the at least one processor, operations of each of the plurality of pieces of equipment into process operations or non-process operations, the operations being included in the history data of each of the plurality of pieces of equipment;
generating, by the at least one processor, based on a result of the classifying, a plurality of training data sets respectively corresponding to the plurality of pieces of equipment from respective history data of the plurality of pieces of equipment;
generating, by the at least one processor based on the plurality of training data sets, a plurality of machine learning models respectively corresponding to the plurality of pieces of equipment;
determining, by the at least one processor based on a plurality of feature importance sets respectively corresponding to the plurality of machine learning models, a plurality of inefficiency indices respectively corresponding to the plurality of pieces of equipment; and
identifying, by the at least one processor based on the plurality of inefficiency indices, at least one piece of abnormal equipment among the plurality of pieces of equipment.

2. The method of claim 1, wherein the generating of the plurality of training data sets comprises:
identifying a non-process type of each of operations classified as the non-process operations, among the operations of each of the plurality of pieces of equipment;
determining, based on the identified non-process type, feature values of a plurality of features for each of the operations classified as the non-process operations; and
generating, for each of the plurality of pieces of equipment, a plurality of training pairs comprising the feature values of the plurality of features as a training input and the identified non-process type as a training output,
wherein the plurality of features comprise features for at least one of a chamber, an idle time, a program, and a wafer related to each of the operations classified as the non-process operations.

3. The method of claim 2, wherein the identifying of the non-process type of each of the operations classified as the non-process operations comprises:
determining a preceding idle time or a subsequent idle time for each of the operations classified as the non-process operations; and
identifying, based on the determined preceding idle time or the subsequent idle time that was determined, the non-process type among a plurality of candidate types,
wherein the plurality of candidate types comprise:
a first type representing a non-process operation performed based on a wafer that has been input in a preceding operation;
a second type representing a non-process operation performed based on a wafer to be input in a subsequent operation; and
a third type representing a non-process operation performed regardless of a wafer input.

4. The method of claim 3, wherein the determining of the feature values of the plurality of features for each of the operations classified as the non-process operations comprises:
when the non-process type of a first operation among the operations classified as the non-process operations is the first type, extracting data about the first operation and a preceding operation of the first operation; and
determining, based on the extracted data, the feature values of the plurality of features for the first operation.

5. The method of claim 3, wherein the determining of the feature values of the plurality of features for each of the operations classified as the non-process operations comprises:
when the non-process type of a first operation among the operations classified as the non-process operations is the second type, extracting data about the first operation and a subsequent operation of the first operation; and
determining, based on the extracted data, the feature values of the plurality of features for the first operation.

6. The method of claim 1, wherein the determining of the plurality of inefficiency indices respectively corresponding to the plurality of pieces of equipment comprises:
generating the plurality of feature importance sets respectively corresponding to the plurality of machine learning models; and
determining the plurality of inefficiency indices respectively corresponding to the plurality of pieces of equipment by comparing feature importance values included in each of the plurality of feature importance sets with each other.

7. The method of claim 1, wherein the determining of the plurality of inefficiency indices respectively corresponding to the plurality of pieces of equipment comprises determining the plurality of inefficiency indices based on an index calculation model corresponding to an abnormality type of the at least one piece of abnormal equipment, among a plurality of index calculation models corresponding to a plurality of candidate abnormality types.

8. The method of claim 1, wherein the identifying, based on the plurality of inefficiency indices, of the at least one piece of abnormal equipment among the plurality of pieces of equipment comprises:
identifying a threshold inefficiency index based on the plurality of inefficiency indices respectively corresponding to the plurality of pieces of equipment; and
identifying the at least one piece of abnormal equipment by comparing the threshold inefficiency index with the plurality of inefficiency indices.

9. The method of claim 1, wherein the identifying, based on the plurality of inefficiency indices, of the at least one piece of abnormal equipment among the plurality of pieces of equipment comprises:
identifying, based on the result of the classifying, a plurality of representative process program identification (PPID) similarities respectively corresponding to the plurality of pieces of equipment from respective history data of the plurality of pieces of equipment;
identifying, based on the plurality of representative PPID similarities, a plurality of characteristic indices respectively corresponding to the plurality of pieces of equipment; and
identifying, based on the plurality of inefficiency indices and the plurality of characteristic indices, the at least one piece of abnormal equipment among the plurality of pieces of equipment.

10. The method of claim 9, wherein the identifying of the plurality of representative PPID similarities respectively corresponding to the plurality of pieces of equipment comprises:
identifying, based on the history data of one piece of equipment among the plurality of pieces of equipment, a preceding PPID and a subsequent PPID for each of all non-process operations included in the history data of the one piece of equipment;
identifying PPID similarities between the preceding PPID and the subsequent PPID for each of all non-process operations; and
identifying, based on the identified PPID similarities, a representative PPID similarity corresponding to the one piece of equipment.

11. The method of claim 10, wherein the identifying of the PPID similarities between the preceding PPID and the subsequent PPID comprises:
converting the preceding PPID and the subsequent PPID into a preceding embedding and a subsequent embedding, respectively; and
identifying vector similarities between the preceding embedding and the subsequent embedding and identifying the identified vector similarities as the PPID similarities.

12. The method of claim 9, wherein the identifying of the plurality of characteristic indices comprises:
normalizing the plurality of representative PPID similarities based on a result of comparing the plurality of representative PPID similarities with each other; and
identifying the normalized plurality of representative PPID similarities as the plurality of characteristic indices respectively corresponding to the plurality of pieces of equipment.

13. The method of claim 9, wherein the identifying of the at least one piece of abnormal equipment comprises:
identifying a plurality of weighted indices respectively corresponding to the plurality of pieces of equipment by multiplying the plurality of inefficiency indices by the plurality of characteristic indices, respectively;
identifying a threshold weighted index based on the plurality of weighted indices; and
identifying the at least one piece of abnormal equipment by comparing the threshold weighted index with each of the plurality of weighted indices.

14. A method, performed by a computing system, of detecting an abnormality of equipment, the computing system comprising at least one processor, a memory, and a communication circuit, the method comprising:
establishing, by the communication circuit, communication with a data collection server;
receiving, by the communication circuit, history data of each of a plurality of pieces of equipment from the data collection server;
classifying, by the at least one processor, a plurality of operations included in the history data of one piece of equipment among the plurality of pieces of equipment into process operations or non-process operations;
generating, by the at least one processor based on a result of the classifying, a plurality of interval training data sets respectively corresponding to a plurality of time intervals from the history data of the one piece of equipment;
generating, by the at least one processor based on the plurality of interval training data sets, a plurality of machine learning models respectively corresponding to the plurality of time intervals; and
identifying, by the at least one processor based on a plurality of feature importance sets respectively corresponding to the plurality of machine learning models, at least one abnormal interval among the plurality of time intervals.

15. The method of claim 14, wherein the identifying of the at least one abnormal interval comprises:
identifying a distribution difference between the plurality of feature importance sets by comparing feature importance distributions of the plurality of feature importance sets with each other; and
when a feature importance set having a distribution difference greater than or equal to a threshold from another feature importance set among the plurality of feature importance sets is identified, identifying a time interval corresponding to the feature importance set that was identified as an abnormal interval.

16. The method of claim 14, wherein the identifying of the at least one abnormal interval comprises:
determining, based on the plurality of feature importance sets, a plurality of inefficiency indices respectively corresponding to the plurality of time intervals; and
identifying, based on the plurality of inefficiency indices, the at least one abnormal interval among the plurality of time intervals.

17. A method, performed by a computing system, of detecting an abnormality of equipment, the computing system comprising at least one processor, a memory, and a communication circuit, the method comprising:
establishing, by the communication circuit, communication with a data collection server;
receiving, by the communication circuit, history data of each of a plurality of pieces of equipment from the data collection server;
classifying, by the at least one processor, operations of each of the plurality of pieces of equipment into process operations or non-process operations, the operations being included in the history data of each of the plurality of pieces of equipment;
obtaining, by the at least one processor based on the history data of each of the plurality of pieces of equipment, process program identifications (PPIDs) of all operations classified as the process operations;
generating, by the at least one processor, a PPID similarity matrix by identifying a PPID similarity between the PPIDs of all operations classified as the process operations;
generating, by the at least one processor, a non-process statistics matrix based on the history data of each of the plurality of pieces of equipment;
generating, by the at least one processor, an abnormality detection matrix based on the PPID similarity matrix and the non-process statistics matrix; and
identifying, by the at least one processor based on the abnormality detection matrix, at least one PPID setting abnormality of one piece of equipment among the plurality of pieces of equipment,
wherein the non-process statistics matrix comprises, for each of the plurality of pieces of equipment, information about a performance frequency of a non-process operation performed prior to each of all operations classified as the process operations,
wherein the abnormality detection matrix comprises a plurality of detection parameters, and
wherein each of the plurality of detection parameters comprises a parameter for classifying, for each of the plurality of pieces of equipment, a probability that each of the PPIDs of all operations classified as the process operations is in an abnormal setting state.

18. The method of claim 17, wherein the generating of the PPID similarity matrix comprises:
converting the PPIDs of all operations classified as the process operations into a plurality of embeddings, respectively; and
identifying a plurality of vector similarities between the plurality of embeddings, and
wherein the generating of the non-process statistics matrix comprises:
identifying, for each of the plurality of pieces of equipment, a number of times each of all operations classified as the process operations has been performed, based on the history data of each of the plurality of pieces of equipment;
identifying, for each of the plurality of pieces of equipment, a number of times the non-process operation has been performed prior to each of all operations classified as the process operations; and
generating the information about the performance frequency of the non-process operation based on the number of times each of all operations has been performed and the number of times the non-process operation has been performed prior to each of all operations.

19. The method of claim 17, wherein the generating of the abnormality detection matrix comprises:
identifying an error between a matrix product of the abnormality detection matrix and the PPID similarity matrix and the non-process statistics matrix;
identifying a plurality of parameters for minimizing the identified error; and
identifying the plurality of parameters that were identified as the plurality of detection parameters of the abnormality detection matrix.

20. The method of claim 17, wherein the identifying of the at least one PPID setting abnormality comprises:
extracting detection parameters of the one piece of equipment from the abnormality detection matrix;
identifying at least one abnormal parameter by comparing the detection parameters of the one piece of equipment with each other; and
identifying at least one PPID corresponding to the at least one abnormal parameter as a PPID in the abnormal setting state.
